(19) United States
(12) Patent Application Publication
(10) Pub. No.: US 2012/0232981 A1
(43) Pub. Date: Sep. 13, 2012

(54) CONTACTLESS WIRELESS TRANSACTION PROCESSING SYSTEM

(76) Inventors: Arthur Torossian, Glendale, CA (US); David Maxwell, Los Angele, CA (US)

(21) Appl. No.: 13/467,935

(22) Filed: May 9, 2012

Related U.S. Application Data
(63) Continuation-in-part of application No. 13/090,191, filed on Apr. 19, 2011.
Application No. 13/090,191 is a continuation-in-part of application No. 13/024,276, filed on Feb. 9, 2011.

(51) Int. Cl. G06Q 30/02; G06Q 20/32; G06Q 30/06

(52) U.S. Cl. 705/14.27; 705/26.61; 705/26.1

(57) ABSTRACT

A wireless transaction processing system that includes a seller account and a buyer account with the buyer having an Internet enabled device that can access the wireless transaction processing system. The wireless transaction processing system, through the Internet enabled device of the buyer enables full processing of transactions without the need for physical cards or an established sales environment. Additionally, the system allows for the direct promotion of products and services to consumers by any entity.

### CROSS-REFERENCE TO RELATED APPLICATIONS

This is a Continuation-In-Part application claiming the benefit of priority of the co-pending U.S. Utility Non-Provisional patent application Ser. No. 13/090,191, with a filing date Apr. 19, 2011, which application is itself a Continuation-In-Part application claiming the benefit of priority of the co-pending U.S. Utility Non-Provisional patent application Ser. No. 13/024,276, with a filing date of Feb. 9, 2011, the entire disclosures of all applications are expressly incorporated by reference in their entirety herein.

### BACKGROUND OF THE INVENTION

1. Field of the Invention

This invention relates to wireless transaction processing system and, more particularly, to contactless transaction processing system using wireless mobile Internet devices.

2. Description of Related Art

Conventional wireless transaction or payment processing systems using wireless devices (such as handheld devices) have been known for a number of years. Most of the conventional wireless transaction or payment-processing systems using wireless devices are vendor-centric. That is, the entire system is designed and implemented with the view that the retailer is the “hub” or the focal point of the payment processing systems for transactions, and most (if not all) functionality to access the conventional wireless transaction or payment-processing systems is initiated by the merchant or the vendor.

Most vendor or merchant-centric systems are based on a retail business-model, which requires a retailer or merchant and a consumer with at least one card account (credit cards, debit cards, etc.). Conventional systems that are used in a retail environment suffer from obvious disadvantages in that they require the retailers or merchants to obtain additional, dedicated specialty wireless hardware or equipment to perform or execute wireless transaction or payment processing. Further, most of the retail or merchant dedicated hardware used for execution of wireless transactions require custom configuration and installation, which further add to the overall cost of providing wireless transaction processing service at the retail or merchant establishment.

Other obvious disadvantages of the conventional wireless transaction or payment processing systems using wireless devices is that they require wireless communication between the handheld device and the dedicated, specialty wireless hardware or equipment at the retail or merchant location. In most cases, wireless communication between any two entities introduces the possibility of interception (by a third party) of that which is wirelessly communicated between the two entities (e.g., the wireless handheld device and the dedicated wireless hardware at the retail or merchant location). With conventional systems, the communication between the handheld device and the merchant specialty equipment include confidential personal information, which further jeopardizes the overall identity and security of the users. Further, the mobile Internet devices must somehow be configured to sync and function or work with the specialty equipment, which makes the mobile Internet device even more vulnerable to identify theft. Additionally, conventional systems developed (e.g., Near Field Communication—NFC) require specialized hardware to be installed either onto or within the wireless device (e.g., mobile phone) for full implementation of conventional wireless transaction or payment processing systems. Still other disadvantages of some conventional wireless transaction processing systems is that they aim to eliminate the use of encryption technology, which further enhances interception of wireless exchange of information between two entities by a third party.

Finally, the merchant or vendor-centric systems or retail business-models mentioned above do not accommodate entity-to-entity direct transactions where both entities are non-retailers or non-merchants (e.g., both entities may, for example, be individual persons).

Accordingly, in light of the current state of the art and the drawbacks to current wireless transaction processing systems mentioned above, a need exists for wireless transaction processing system that would be consumer-centric where the entities such as retailers or consumers (e.g., the mobile devices used) are not required to obtain additional, dedicated specialty wireless hardware or equipment to perform or execute wireless transaction or payment processing. Further, even if such transactions are accomplished wirelessly using additional wireless equipment, no personal or private confidential information is exchanged. Additionally, a need exists for a consumer-centric wireless transaction processing system where information exchanged is encrypted for security. Furthermore, a need exists for a consumer-centric wireless transaction processing system that would enable personal, direct transactions between individuals without requiring credit cards, involvement of retailers or merchants, or the involvement of fund transferring institutions. Finally, a need exists for integration of most types of transactions, including, but not limited to, most cashless transactions, payment, purchasing, and direct fund transfer between entities within a single system accessed by an Internet enabled mobile device.

### BRIEF SUMMARY OF THE INVENTION

An exemplary optional aspect of the present invention provides a wireless transaction processing system, comprising:

a remote transaction module (RTM);

a RTM database that includes RTM item data for a product or service;

a RTM item ID associated with the RTM item data for the product or service;

the RTM item ID used in a variety of media, enabling access to and retrieval of the RTM item data associated with the product or service from one or more servers of WTPS, to display content of the RTM item data on the mobile device.

Another exemplary optional aspect of the present invention provides a wireless transaction processing system, wherein:

the displayed content of the RTM item data includes various controls for selection and transaction processes for the product or service, including further recommendations related to the selected product or service.

Another exemplary optional aspect of the present invention provides a remote transaction (RT) system, comprising:

a RT database that includes RT item data for a product or service;

a RT item ID associated with the RT item data for the product or service;

the RT item ID used in a variety of media, enabling access to and retrieval of the RTM item data associated with the product or service from one or more servers of RT, to display content of the RT item data on the mobile device.

Another exemplary optional aspect of the present invention provides a RT system, wherein:

the displayed content of the RT item data includes various controls for selection and transaction processes for the product or service, including further recommendations related to the selected product or service.

Another exemplary optional aspect of the present invention provides a wireless transaction processing system (WTPS), comprising:

a loyalty module (LM);

a LM database that includes LM item data for a promotion or reward;

a LM item ID associated with the LM item data for the promotion or reward;

the LM item ID used in a variety of media, enabling access to and retrieval of the LM item data associated with the promotion or reward from one or more servers of WTPS, to display content of the LM item data on the mobile device.

Another exemplary optional aspect of the present invention provides a loyalty system, comprising:

a loyalty database that includes loyalty item data for a promotion or reward;

a loyalty item ID associated with the loyalty item data for the promotion or reward;

the loyalty item ID used in a variety of media, enabling access to and retrieval of the loyalty item data associated with the promotion or reward from one or more servers of loyalty system, to display content of the loyalty item data on the mobile device.

Another exemplary optional aspect of the present invention provides a system, comprising:

an integration between a loyalty system and a remote transaction system that allows for immediate purchase or redemption of at least one item presented through the loyalty system.

Another exemplary optional aspect of the present invention provides a wireless transaction processing system (WTPS), comprising:

a unified commerce architecture for multi-platform transactions and communications between disparate and distinct entities.

Another exemplary optional aspect of the present invention provides WTPS, wherein:

the unified commerce architecture includes one or more multi-configurable devices, enabling multi-platform transactions and communications between disparate and distinct entities.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1A is a non-limiting, exemplary system overview of the wireless transaction processing system in accordance with the present invention;

FIG. 1B is a non-limiting, exemplary illustration of an online registration scheme of a wireless transaction processing system in accordance with the present invention for seller and buyer memberships;

FIG. 1C-1 is a non-limiting, exemplary illustration of a set of information accessed by a buyer after login to the personal wireless transaction processing system account;

FIG. 1C-2 is a non-limiting, exemplary illustration of additional WTPS default end-user account tools, which may be available after login for various accounts;

FIG. 1D is a non-limiting, exemplary illustration of computer system(s) of a wireless transaction processing system platform in accordance with the present invention;

FIG. 1E is a non-limiting, exemplary illustration of a well-known, conventional mobile Internet device that may be used with the wireless transaction processing system in accordance with the present invention;

FIG. 1F is a non-limiting, exemplary detailed system overview of the wireless transaction processing system within the context of an overall credit/debit card transaction system in accordance with the present invention;

FIGS. 2A to 2N are non-limiting, exemplary flowchart illustrations of the wireless transaction processing system in accordance with the present invention;

FIGS. 3A to 3E are non-limiting, exemplary flowcharts illustrating a process of transfer of funds from one individual or entity to another individual or entity using the wireless transaction processing system in accordance with the present invention;

FIG. 4A is a non-limiting, exemplary system overview of the wireless transaction processing system integrated within existing credit/debit transaction system in accordance with the present invention;

FIGS. 4B to 4D are non-limiting, exemplary flowchart illustrations of the details of the wireless transaction processing system integrated within a credit issuing entity in accordance with the present invention;

FIGS. 5A to 5E are non-limiting, exemplary illustrations of additional transactional architecture systems within which the WTPS platform may be used in accordance with the present invention;

FIGS. 6A to 6F are non-limiting, exemplary illustrations of remote transaction in accordance with the present invention;

FIGS. 7A to 7C-2 are non-limiting, exemplary illustrations of loyalties in accordance with the present invention; and

FIGS. 8A to 8B are non-limiting, exemplary illustrations of integrated loyalty and remote transaction modules in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

For purposes of illustration, programs and other executable program components are illustrated herein as discrete blocks, although it is recognized that such programs and components may reside at various times in different storage components, and are executed by the data processor(s) of the computers. Further, each block within a flowchart may represent both method function(s), operation(s), or act(s) and one or more elements for performing the method function(s), operation(s), or act(s). Each block may comprise of one or more protocol(s) for execution of one or more function(s), operation(s), or act(s). In addition, depending upon the implementation, the corresponding one or more elements may be configured in hardware, software, firmware, or combinations thereof.

This disclosure defines the term “product” or “products” as good(s) and or service(s) (virtual or real) provided by an entity. Accordingly, a “product” for a manufactures may for example, be an article, whereas a “product” for an attorney or an accountant may be the service provided.

This disclosure defines a seller as one or more entity that promotes (e.g., using coupons), exchanges, or sells product(s). Non-limiting examples of a seller may include, for example, a vendor, retailer, merchant, wholesaler, dealer, resellers or value added resellers or VARs, professional entities such as accountants, attorneys, landlords with rental property, etc.

This disclosure defines a buyer as one or more entity that may be involved in a transaction with a seller. Non-limiting examples of a buyer may include, for example, a purchaser of a product or service, consumer, purchasing entity such as a corporation, a tenant, etc.

Further, in certain instances (depending on the context used) the term “user” or “end user” may refer to buyer, seller, or both. In addition, a seller may become a buyer or vice versa. For example, a merchant is a seller, but a merchant may buy from their respective vendor and hence, the merchant becomes a buyer. As another example, a buyer may sell a product, which makes the buyer a merchant.

It should further be noted that a transactional environment may generally be defined as one where any expenditure of funds or money (direct or indirect) is exchanged between entities and may involve purchase for goods and or services.

A seller may have a physically existing real world “brick-and-mortar” location or presence, and or have an online or virtual presence (or remote presence). It should further be noted that there are instances where a seller may have a physical, online, and or remote presence. For example, a bookstore may have an online presence, have a physically existing presence in a physically existing geographic location such as in a city, and have a remote presence such as placement of an ad in TV commercials, magazine or others' website or on a billboard ad in another state or country.

Throughout the disclosure terms such as bank, merchant bank, buyer bank, third party processors, credit-issuing entities, and so on generally refer to any entity (generally a financial institution) that may handle various types of transactions (virtual, real, or electronic funds). In general, any reference to a financial intuition should be interpreted as any entity that issues or authorizes a payment account (virtual, real, or electronic, and issuing or acquiring). Therefore, the phrase “credit issuing bank” or “credit issuing entity” should not be limited to those institutions that issue lines of credit, but may include any entity that issues any form of payment account. It is well known that a financial entity may be a merchant bank to a seller at the same time that the same financial entity is also a buyer bank to a buyer and further, the same financial entity may or may not also function as a third party processor for the seller. Of course, the financial entities may also be completely separate entities or, alternatively, may be a division or a subsidiary of a larger financial entity. Accordingly, it is only for clarity and better understanding of the invention that in some instances the disclosure may distinguish a financial entity in drawings and description as non-limiting, exemplary “acquiring merchant bank” or “credit issuing bank” and so on even though these terms may or may not refer to the same entity throughout.

It should further be noted that communication protocols must be established between the consumer-centric contactless wireless transaction processing system (WTPS) of the present invention and other entities to enable WTPS systems (servers, computers, etc.) and systems of other entities to communicate. Establishment of communication protocols between entities (any entity) are well known and routinely executed to enable secure, appropriate authorized access to servers and computers of the entities involved for various transactions, commensurate with previously established agreements between the entities. The communications protocols may be implemented in variety of well known manners, non-limiting example of which may include exchange or use of various Application Programming Interface (API) modules and or Software Development and or Software Development Kits (SDK) approved by entities involved.

For the purposes of this disclosure, the interchangeable terms such as loyalty or loyalties, loyalty program, loyalty system, and so on are defined as a system used by entities to encourage and entice transactions. Non-limiting examples of loyalty programs may include rewards (e.g., membership clubs, buyer discount programs, etc.) and or promotions (e.g., coupons, etc.).

The present invention provides a wireless transaction processing system (WTPS), comprising a unified commerce architecture for multi-platform transactions and communications between disparate and distinct entities. The unified commerce architecture includes one or more multi-configurable devices, enabling multi-platform transactions and communications between those disparate and distinct entities.

The present invention provides a consumer-centric contactless wireless transaction processing system (WTPS) using wireless mobile Internet devices. The consumer-centric contactless transaction processing system of the present invention using wireless mobile Internet devices obviates the mandatory requirement for the entities such as retailers to obtain additional, dedicated specialty wireless hardware or equipment to perform or execute wireless transaction or payment processing. Further, even if such transactions are done wirelessly using specialty equipment, no personal or private confidential information is exchanged when using the wireless transaction processing system of the present invention during the transaction process. Additionally, the consumer-centric contactless wireless transaction processing system of the present invention exchanges information using encryption and other well-known methodologies for security. Furthermore, the wireless transaction processing system of the present invention enables personal, direct transactions between individuals. Finally, contactless transaction processing system using wireless mobile Internet devices of the present invention integrates most types of transactions, including, but not limited to, cashless transactions, remote transactions, payments, purchasing, loyalty based transactions, recurring payments, virtual funds, or direct fund transfer (real or virtual, including electronics) between entities within a single system accessed by a mobile device.

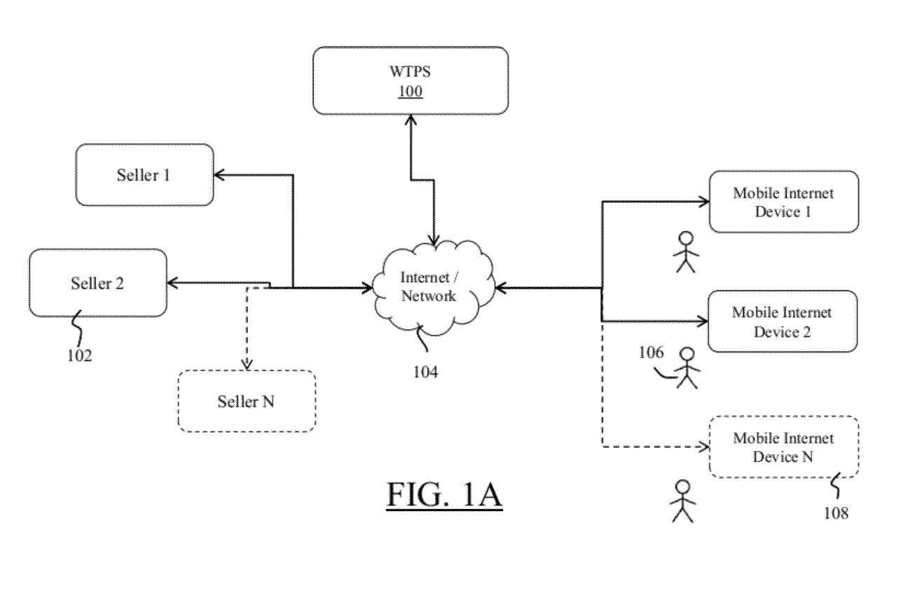

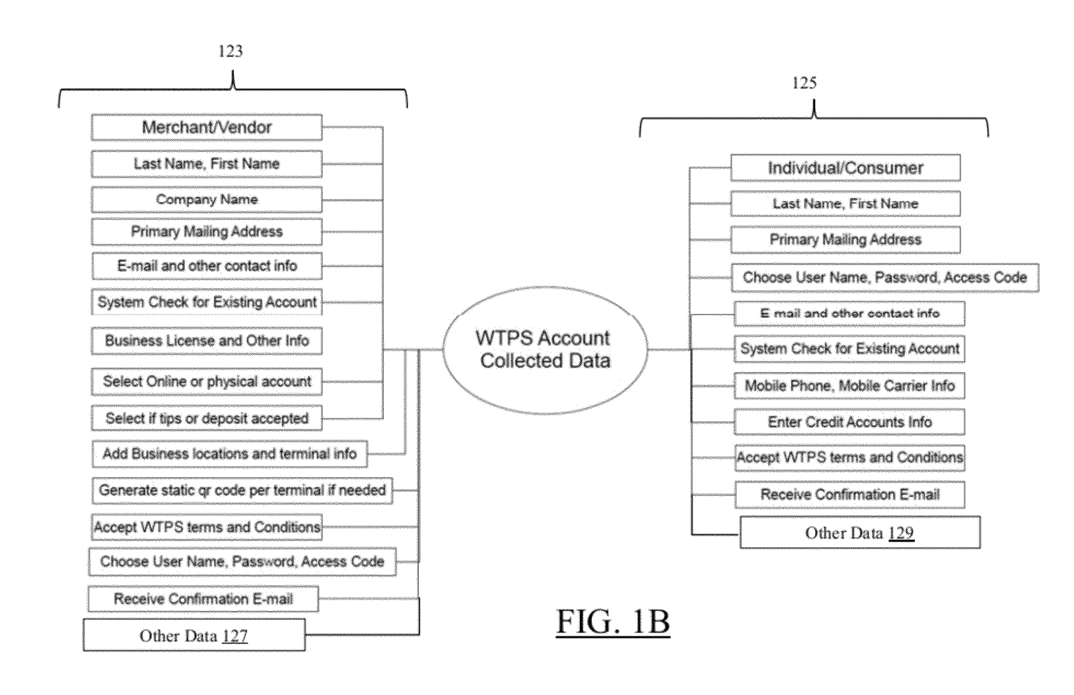

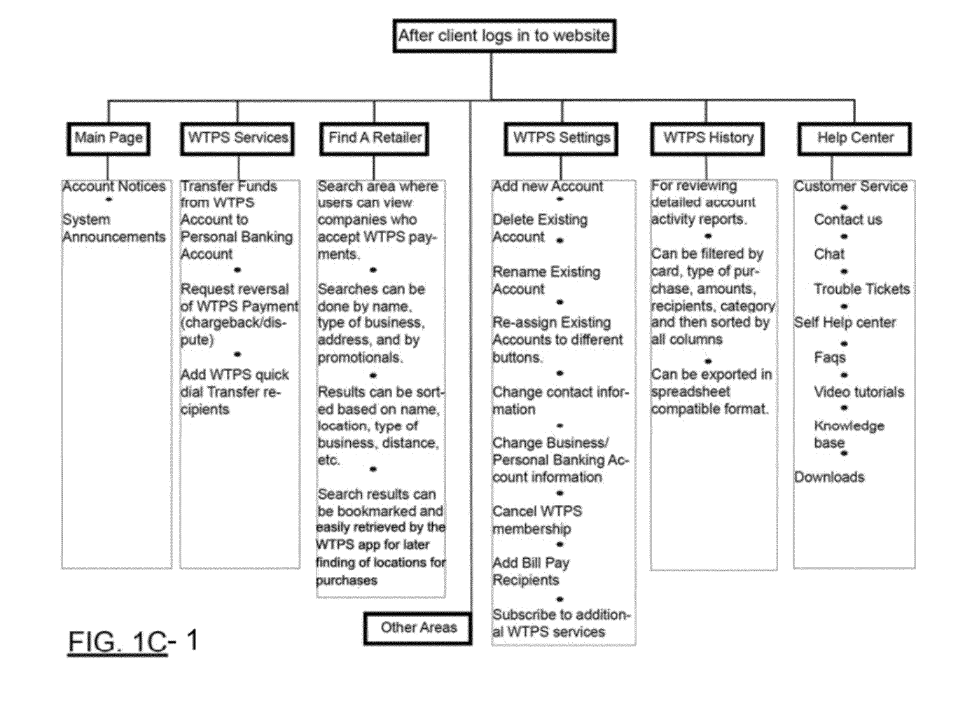

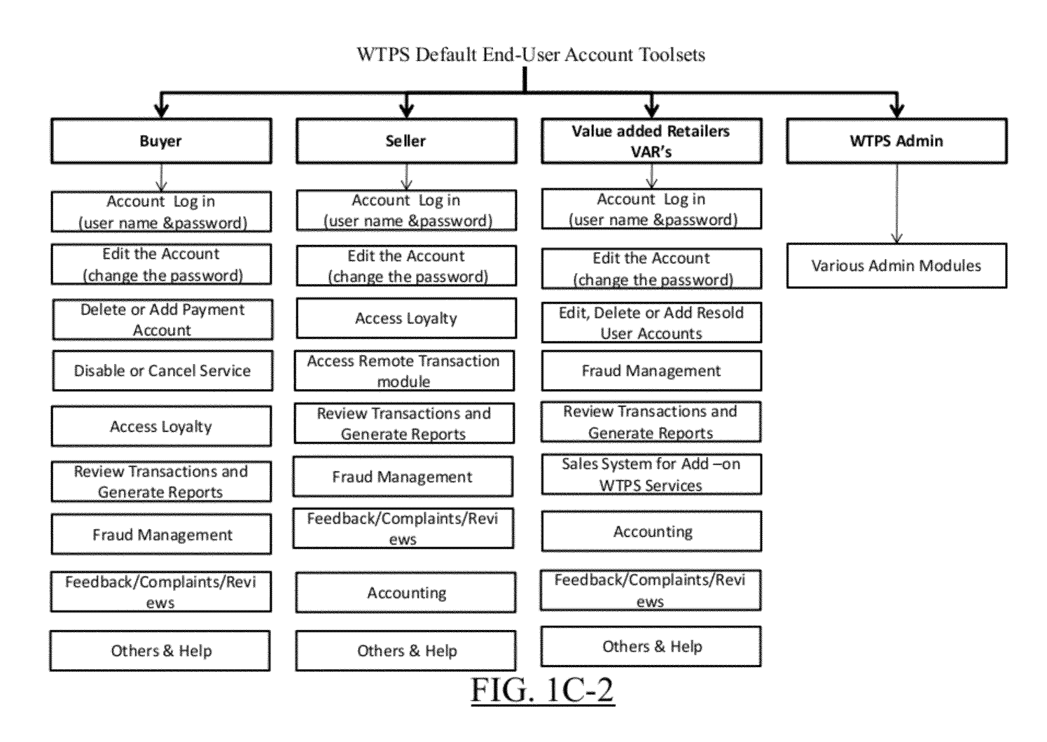

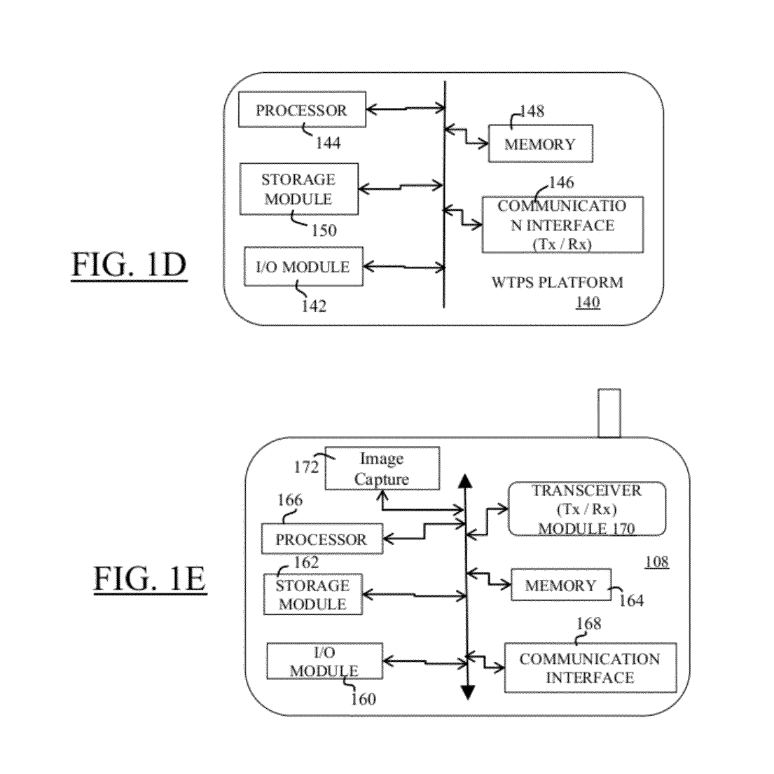

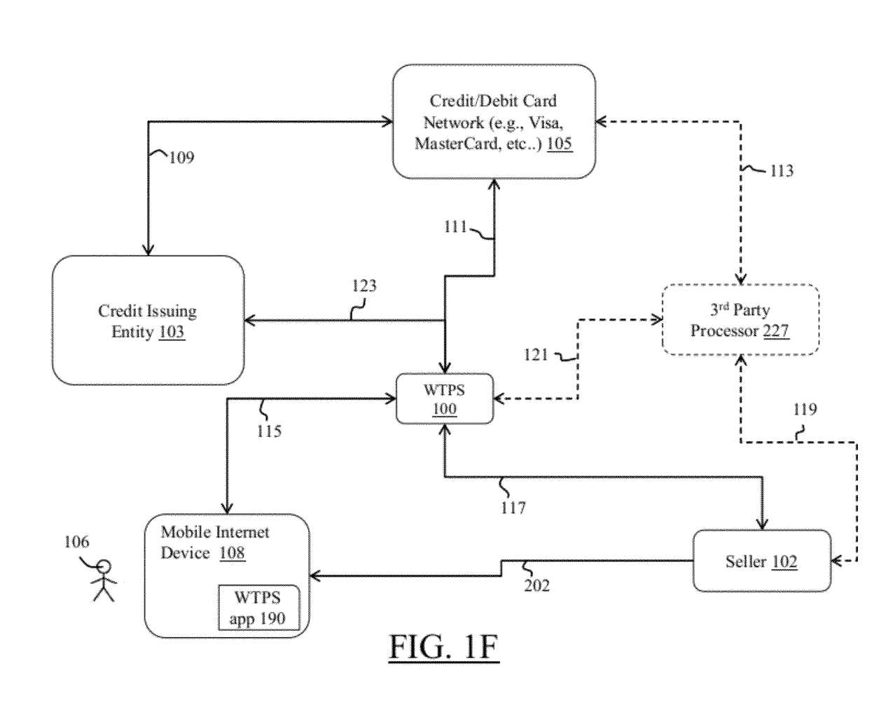

FIG. 1A is an exemplary system overview of the wireless transaction processing system in accordance with the present invention. As illustrated, the consumer-centric contactless wireless transaction processing systems (hereinafter referred to as “WTPS”) 100 of the present invention includes one or more seller 102 that is associated with the WTPS 100, and communicatively associated therewith via Internet or a network 104. In this exemplary instance, the seller 102 is a seller that is a registered member of the WTPS 100, and may (for example) be a neighborhood convenient store.

As further illustrated, the WTPS 100 of the present invention includes one or more buyer 106 that is associated with the WTPS 100, and communicatively associated therewith via Internet or a network 104 using a mobile Internet device 108. In this exemplary instance, the buyer 106 is a registered member of the WTPS 100, with the buyer having at least one Internet enabled device 108 that can access the WTPS 100 via the Internet or network 104.

As a non-limiting example, with the WTPS 100 of the present invention, a buyer 106 that is a member of the WTPS 100 may walk into a convenient store 102 that is also a member of the WTPS 100 without carrying any cash or credit cards, purchase the desired products of the seller 102, and complete a transaction for purchase of the products using the mobile Internet enabled device 108. The seller 102 is not required to have any specialty equipment, and no confidential information is exchanged between the seller 102 and the member buyer 106.

As yet another non-limiting example, with the WTPS 100 of the present invention, a first individual member may directly transfer funds to a second individual member anywhere at any time for immediate use (depending on the banking institutional policies) by the second individual member using the mobile Internet device 108, and without accessing their respective bank accounts, or requirement of any specialty equipment. Further examples of other functionalities of WTPS 100 are detailed below.

FIG. 1B is an exemplary illustration of an online account creation scheme of a wireless transaction processing system in accordance with the present invention for seller 102 and buyer 106 memberships. As with most conventional online account creation schemes, seller 102 and buyer 106 may access the online account creation site of the wireless transaction processing system website to create an account and register with the WTPS. The required information and processing for creation of an account and registration is similar to known processes that create conventional online bank accounts with most commercial banks. It should be noted that after a buyer becomes a registered member of the wireless transaction processing system (by providing the information referenced as 125), a mobile app (or a mobile application) of the WTPS is automatically downloaded to the registered mobile Internet device 108 (such as a mobile phone) of the registered buyer 106, where the buyer 106 can associate and communicate with the WTPS. On the other hand, after a seller 102 becomes a registered member of the WTPS (by providing the information referenced as 123), the registered seller 102 can associate and communicate with the WTPS by a variety of means, including a seller computer, mobile device (associated with the WTPS during registration), specialty equipment (if desired), or simple mobile phone (associated with the WTPS during account creation process).

The WTPS account creation process requires seller and buyer identification information (referenced as 123 and 125), non-limiting, non-exhaustive list of examples of which are exemplarily illustrated in FIG. 1B, including device-ID for their respective mobile Internet devices, business information of the seller, and so on. It should be noted that the type and amount of information required to become a registered member of WTPS will vary based on the form of a WTPS account established. For example, certain accounts (e.g., a manufacturing entity) may not require “tips or deposits.”

After creating an account, end-users are assigned with a WTPS member ID that fully identifies each registered user, equipment, etc, which may be represented by a variety of means, non-limiting example of which may include alpha-numeric characters, image, signal (wired or wireless), or others. That is, during account creation process, the buyer 106 and seller 102 WTPS account(s) is created with a unique WTPS ID that the WTPS may reference during any transaction process. The unique WTPS ID referenced by WTPS may reference the information that is exemplary illustrated in FIG. 1B. It should be noted that the listing of information 123 for the seller 102 and the listing of information 125 for the buyer 106 provided in FIG. 1B is non-exhaustive and should not be limiting.

It should further be noted that the account creation process described in relation to FIG. 1B should not be limited to direct registration of sellers 102 and buyers 106 with WTPS, but is equally applicable to third party entities. For example, a financial institution or entity such as bank may wish to offer WTPS as an added service to their valued customers such as buyers 106 that have an account with the bank or sellers 102 that have a merchant account with the bank. In such an instance, the buyers 106 or sellers 102 need not directly create an account with WTPS, but become a registered member through the bank that offers WTPS as an added service. In other words, instead of individual buyer 106 or seller 102 directly providing the required information 125 and 123 that is exemplarily illustrated in FIG. 1B, that same information is provided by the bank (or any other third party entity) for each of their accounts (personal account or merchant account). This facilitates and aids the third party entity such as a bank to register their entire set of existing accounts with WTPS at an instance rather than asking each of their account holders (seller or buyer) to sign-up individually.

As with individual account creation, the creation of an account through a third party entity (e.g., a VAR) would also generate unique WPTS ID for the individual end-user internally referencing the third party entity within the WTPS. In other words, WTPS provides the mechanism to always uniquely identify an account, whether directly registered or through a third party entity, and further, provides the mechanism to actually identify the third party entity itself. The identification of the third party entity itself is through the other data 127 and 129 indicated in FIG. 1B, which may be data related to additional information that may be required to identify the third party entity. It should be noted that if a buyer 106 is directed to the WTPS through a third party entity, the information indicated as reference 125 is provided to the WTPS through the third party entity, and if a seller 102 is directed to the WTPS through a third party entity, the information indicated as reference 123 is provided to the WTPS through the third party entity. It should be noted, as detailed below, after creating an account, end-users may access their respective WTPS accounts using normal user ID and password or pin, and need not use their WTPS IDs. It should be noted that in certain instances a third party entity may require its own exclusive, proprietary databases or server installations having an exclusive “private” use of the WTPS for their own implementation in which case, an end user (also associated with the third part) may end up having two unique WTPS IDs, with one ID as result of direct WTPS membership, and the other as a result of membership or association within the third party entity private WTPS installation.

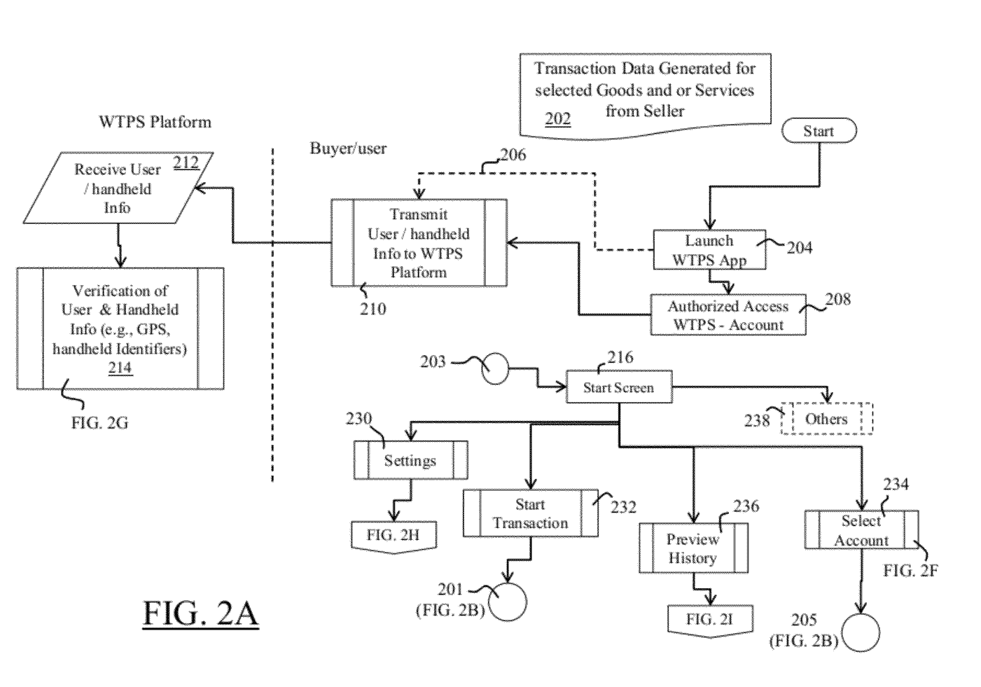

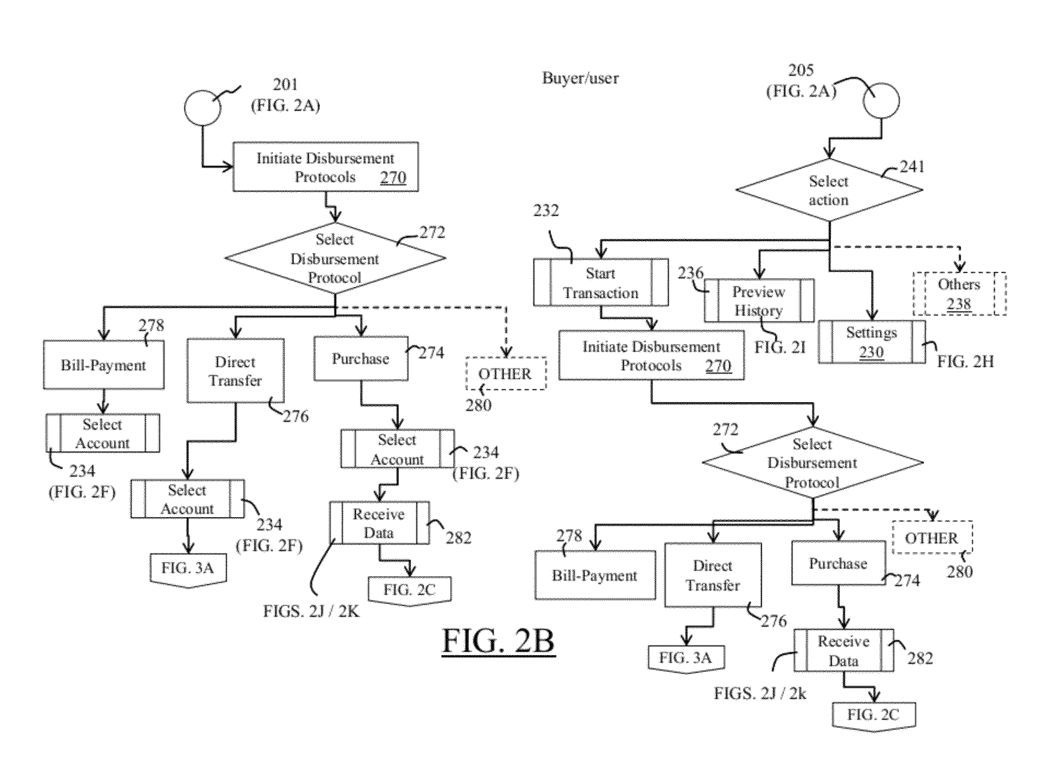

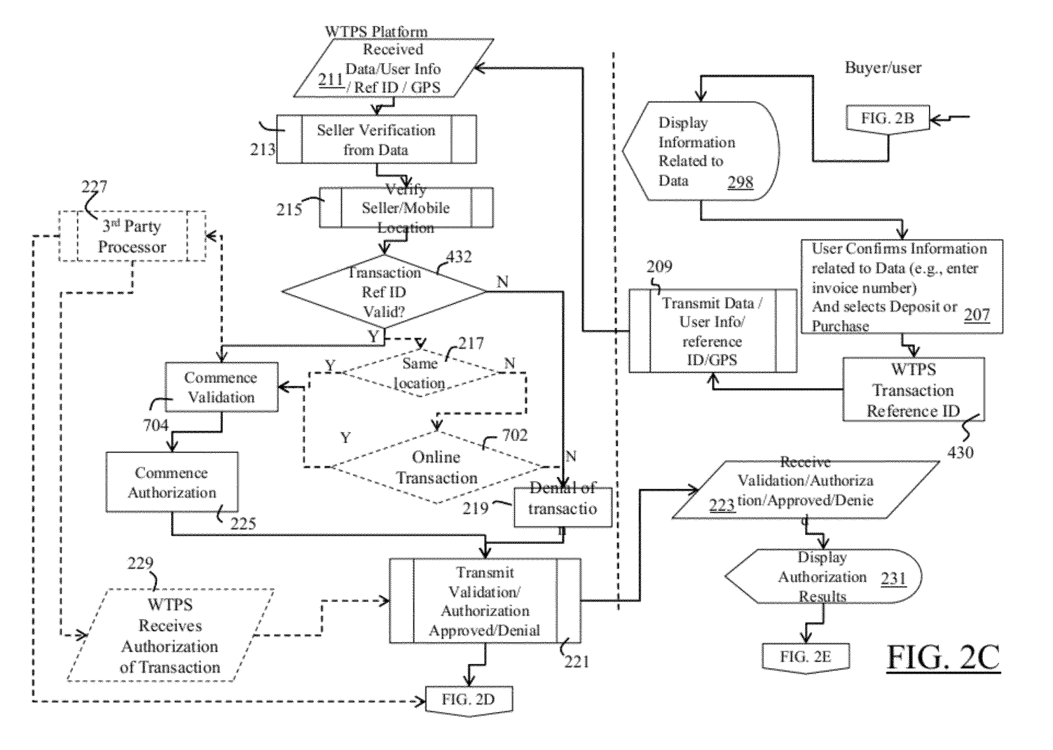

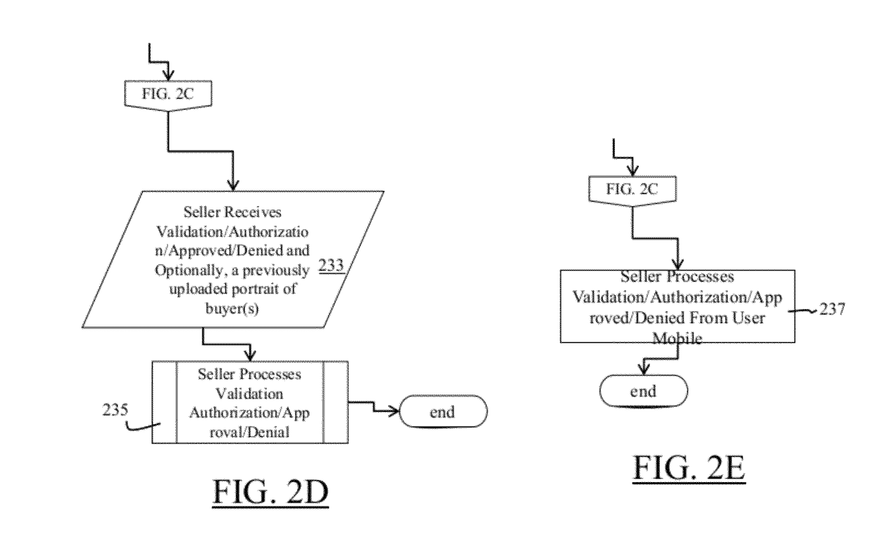

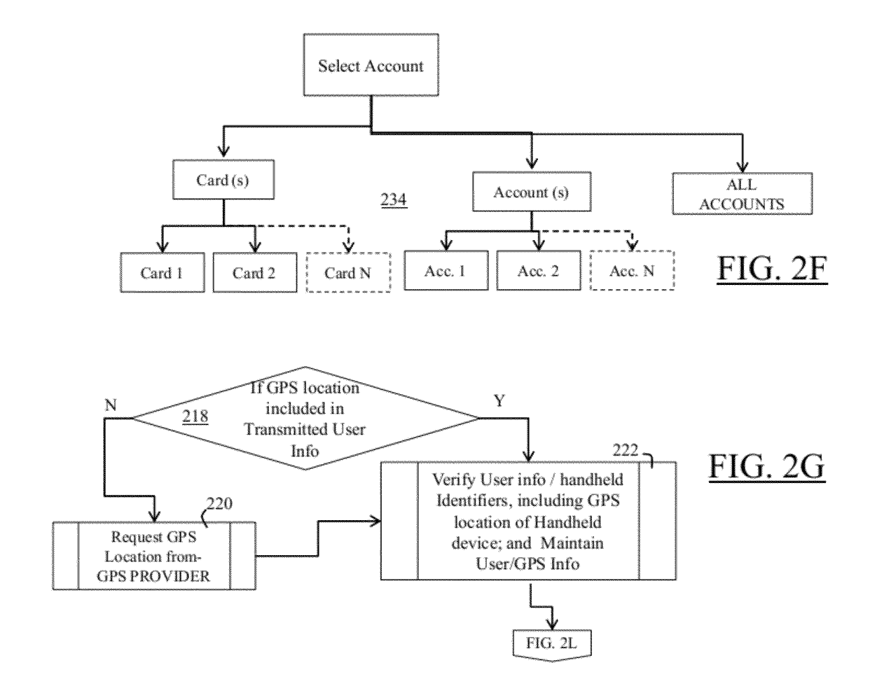

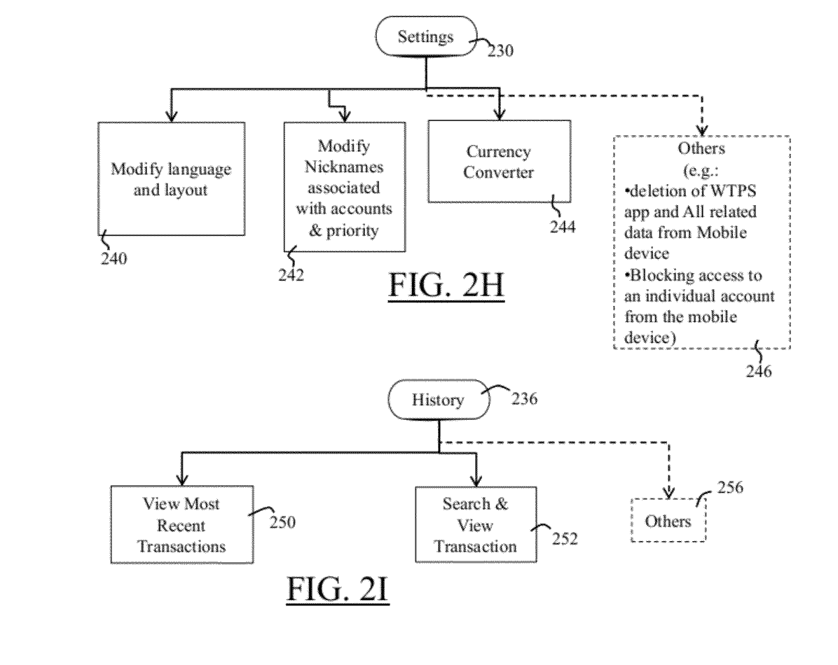

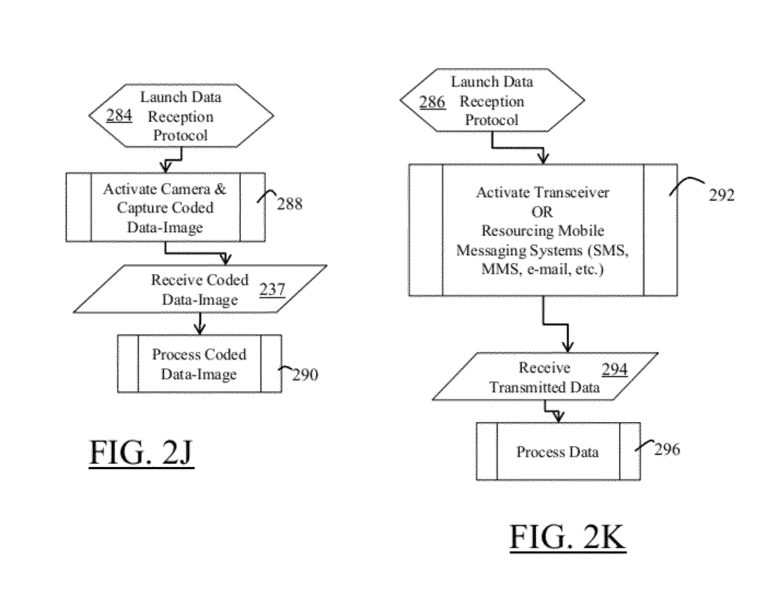

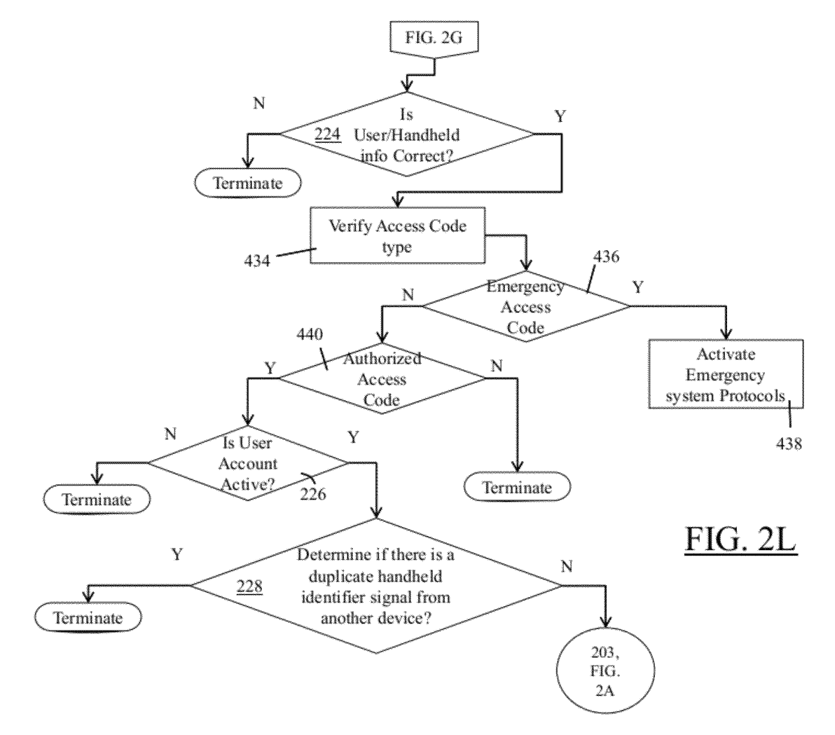

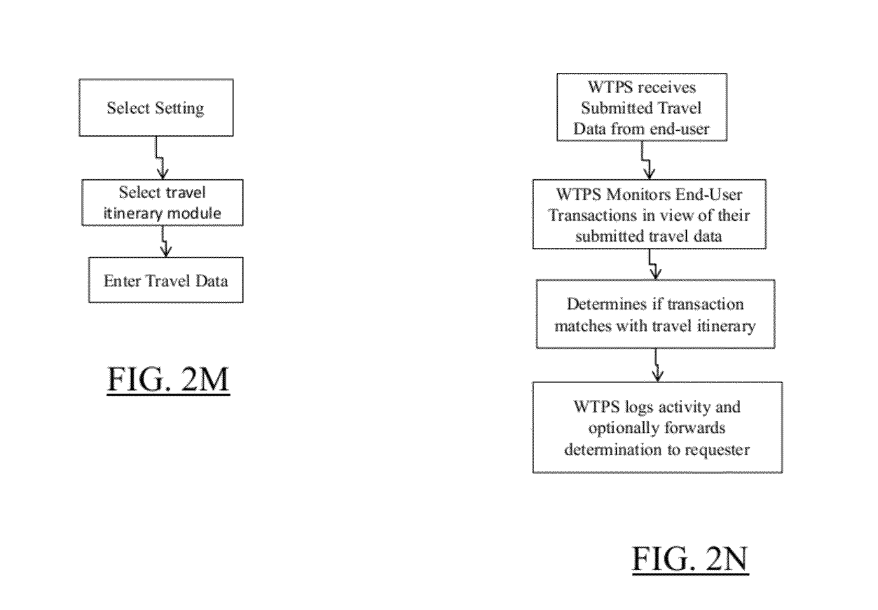

Accordingly, there are at least two methods for an end-user to create an account with WTPS, direct or indirect (e.g., via a VAR, for example). If an end-user account is created by a reseller (e.g., VAR) either through direct entry through WTPS website, then the reseller enters identifying information 123 listed in FIG. 1B, which includes but is not limited to user name and password, email address, company name, contact name, address, contact phone numbers, seller account provider, seller account number, company locations, online or physical use, whether or not company accepts tips at their locations, whether or not the company accepts deposits at their locations, seller authorization terminal ID (e.g., a credit card terminal) information for each credit card terminal that the end-user uses at each location. In this method, the end-user (for which the VAR created the account) is given a login and password for them to go to WTPS website, login and access the available tool modules (FIG. 1C-2) available within the WTPS end-user web portal. Using WTPS website user tool module (FIG. 1C-2) allows end-user (whether direct or indirect sign-up) to access functions to enable them to take advantage of the services and features of WTPS. This includes but is not limited to entering products or services into remote transaction database (detailed below), generating static ID codes (e.g., illustrated within QR codes) for printing or copying, creating promotions for the loyalty GPS system, reviewing transactions made by the user from WTPS, updating account information, downloading programs or programmed add-ons for users with WTPS user accounts, etc.

In general, a transaction begins with generation of a transaction data 202 (detailed below) that includes a WTPS ID of the seller 102 being presented by the seller 102 to the perspective buyer 106. The transaction data 202 (which includes the seller WTPS ID) only has information that is non-confidential and not private, and may be represented by a variety of different ways that are detailed below, non-limiting examples of which may include a QR code, a Wireless Data Transmission, an NFC transmission, a Coded Image, or other method of data representation. The seller WTPS ID is created at the time of registration for the seller either by direct registration or by reseller creation. The WTPS ID indicates the database entry and file in the WTPS system. By logging into the merchant portal through the associated WTPS website, the seller is able to access various account tools (shown in FIG. 1C-2) provided by the WTPS. These tools include, but are not limited to, a web based WTPS QR code generator, account activity history reports, and a download area offering applications ranging from a credit card authorization terminal program (CCATP) to Software Development Kits (SDK's) and API's for adding to various merchant point of sale (POS) systems and platforms for implementing WTPS in different 3rd party systems.

It should be noted that the CCATP may be alternately downloaded and provided by the third party processor for the seller. It should be further noted, that the CCATP facilitates the generation of the transaction data image (e.g., a QR code) at the terminal level. At no time during the transaction process is the terminal required to connect with an external server in order to begin the transaction process. The CCATP program for generating a terminal level transaction data image is similar to well known QR generators, which are readily available standalone open-source software, with the addition of routine Application Programming Interface to enable installation within the CCATP terminal. Nonetheless, after downloading the CCATP, the seller follows a series of installation steps including the entry of WTPS seller ID into the terminal application. The CCATP, at the time of transaction, once the buyer or seller has selected to use WTPS as a payment method will generate a data image (e.g., a QR code) representative of, but not limited to, the saved WTPS merchant ID, dollar amount, and merchant transactional reference ID. This data image (i.e., the transaction data 202) is what is received by and processed by the buyer at the start of the WTPS transaction process.

After logging into the WTPS, end-users (buyers, sellers, reseller, etc.) access their respective WTPS user account web portal. FIG. 1C-1 is a non-limiting, exemplary illustration demonstrating a typical WTPS buyer account web portal, which has similar functionalities as seller or reseller account web portals with minor variations. That is, each of the respective WTPS user account web portal functionalities (for buyer, seller, reseller, etc.) are commensurate with end-user type. For example, a WTPS seller account web portal would not traditionally include functions related to resellers or buyers, since it would not be necessary. However, it is possible for an end-user account to be classified and offer functions (or tools) associated with multiple account types. For example, a seller that wishes to make purchases from their vendors using the WTPS system would have available tools such as a buyer type transaction history and the ability to associate transactional accounts (e.g., credit card accounts) for purchasing.

As with most conventional online banking account schemes, a user (in this example, a buyer 106) may access their online account after login through any Internet enabled device. A WTPS user account (e.g., buyer, seller, etc.) includes typical information about user account details, such as transaction histories, account contact information and settings, account options, and other typical, well-known tools such as a help center, other services, and so on, the creation and uses of which are very well-known and similar to most online banking websites, as illustrated in FIG. 1C-1. Non-limiting, non-exhaustive list of examples of tools and information available in a WTPS user account may include but not limited to association of personal accounts (such as credit, debit, checking, saving, investments, or other accounts) with the WTPS, assignment of the associated account with a graphic user interface (GUI) for use, such as a soft button, the storing or searching of loyalty promotions and rewards, the creation of new loyalty promotions (in the case of seller accounts) and the creation of new remote purchasing products (in the case of a seller accounts) or enabling or registration of new merchant accounts (in the case of VAR accounts).

FIG. 1C-2 is non-limiting, exemplary illustration of end-user tool modules for various types of user accounts. It should be noted that while each account type (buyer, seller, reseller, etc.) may have default tool modules offering a set group of functions and features, it is possible for an end-user account to be classified under multiple account types. Each user account is categorized within a particular class based on the user account type. For example, buyer accounts may be categorized as one class of accounts, and seller accounts categorized as another set of classified account. In that instance, the end-user will have access to all tool modules available for their associated account classifications. The illustrated, WTPS Admin account is a specialty account for WTPS administrators with usual admin privileged access to the entire WTPS system for management and moderation.

As illustrated in FIG. 1C-2, there are tool modules that are universal to all classification categories, and there are other tool modules that are specialized for particular class of accounts. Further, there are tool modules that may be universal to all classified account types, but depending on the type of the account classification, each has access to various aspect of that module. Non-limiting examples of tool modules that are universal across all categories of classified account types include account log in, edit account, and help module that have well known functionalities.

Non-limiting examples of tool modules that are specialized for particular class of accounts may include delete or add payment account toot module, which is available to buyer accounts. The delete or add payment account toot module for the buyer account enables the buyer to add or delete a payment account. As another example of specialized tool module, access remote transaction module is a specialized tool module that is reserved for seller accounts (remote transaction module is detailed below). As a further example of a specialized tool module, edit, delete, or add resold user account module is a specialized tool module that is only available for reseller accounts, which enables the reseller accounts to modify user accounts. The reseller accounts further include the sales system for add-on WTPS services specialized tool module, which is used by reseller accounts for selling to end users additional services and account add-ons that WTPS offers.

As indicated above, there are tool modules within WTPS that may be universal to all classified account types, but depending on the type of the account classification, each has access to various aspect of that module. For example, the access Loyalty module is available to both buyer and seller accounts; however, where a seller account will access the Loyalty module to create (or modify) Loyalties (detailed below), the buyer account will access the loyalty module to merely redeems them. As another example, the Feedback/Complaints/Reviews module may be considered universal, but each account type will have different types of functions for reviews. For example an end-user (e.g., buyer) can search through list of merchants based on merchant rating and review level, but another end-user (e.g., merchant) cannot search consumers (e.g., buyers) based on review and rating levels. As yet another example of universal tool modules with specialized access privileges, the Disable or Cancel service tool module allows the buyer to cancel WTPS service or disable the WTPS app within their mobile internet device 108. On the other hand, although not illustrated, seller and reseller accounts may cancel their WTPS service. As a further example, the Review Transactions and Generate Reports module enables a buyer account to review and generate buyer transactions (such as purchases), a seller account to review and generate seller transactions (purchases, and sales), and the reseller account to review and generate reseller transaction (such as reviewing transaction history for resold accounts). As yet another example, the Fraud Management module may enable buyer accounts to submit claims of suspected fraud or chargebacks, etc., seller account to respond to claims of fraud or chargebacks, and reseller accounts to moderate the claims of fraud or chargebacks of resold accounts. As a final example, the Accounting module may enable seller accounts to manage accounts payable, while reseller accounts would manage accounts receivable and payable.

FIG. 1D is an exemplary illustration of computer system(s) of a wireless transaction processing system platform in accordance with the present invention. The computer system(s) of the wireless transaction processing system platform 140 may comprise of one or more computers or servers in one or more locations. As illustrated in FIG. 1D, the one or more servers 140 is comprised of an input and output (I/O) module 142 for receiving information and or data from various entities, including, but not limited to various admin users, mobile Internet devices, sellers, buyers, or others, including any inputting mechanism, such as a communication module, an external computer connected to the platform, a network and or Internet connection, or any computer readable medium such as a floppy disk, Compact Disk (CD), a Digital Versatile Disk/Digital Video Disk (DVD), and a removable hard drive. The I/O module 142 may also be configured for receiving user input from another input device such as keyboard, a mouse, or any other input device best suited for the current environment conditions. Note that the I/O module 142 may include multiple “ports” for receiving data and user input, and may also be configured to receive information from remote databases or computer or servers using wired or wireless connections. The I/O module 142 is connected with the processor 144 for providing output to various entities, possibly through a video display. Output may also be provided to other devices or other programs, e.g. to other software modules, for use therein, possibly serving as a wired or wireless gateway to external databases or other processing devices such as mobile Internet devices 108. Further included is communication interface 146, which may include a wireless or wired transceiver Tx/Rx for implementing desired communications protocols. The processor 144 is coupled with a memory 148 to permit software such as control information to be manipulated by commands to the processor 144, and storage module 150 for storage of data.

FIG. 1E is an exemplary illustration of a well-known, conventional mobile Internet device that may be used with the wireless transaction processing system in accordance with the present invention. As illustrated, the mobile Internet device 108 is any well-known conventional mobile Internet device, including netbooks, notebooks, laptops, mobile phones, or any other device that is Internet enabled. The mobile Internet device 108 includes the typical, conventional components such as an I/O module 160 (e.g., a display, etc.), a storage module 162 for storing information, a memory 164 used by a processor 166 to execute programs, a communication interface 168 for implementing desired communication protocol, a transceiver module 170 for transmitting and receiving data, and may or may not include an image capture device such as a camera 172. The mobile internet device 108 uses the wireless transaction processing system mobile application to communicate with the WTPS 100 in order to process transactions.

FIG. 1F is an exemplary embodiment, which details system overview of the wireless transaction processing system within the context of an overall credit/debit card transaction system in accordance with the present invention. The Internet/Network 104 shown in FIG. 1A is removed from the illustration in FIG. 1F for simplicity and ease of illustration to avoid clutter, and for better understanding. However, it is readily apparent and should be obvious to those skilled in the art that wireless communication by entities involved are in general through the Internet/Network 104. Therefore, the non-limiting, exemplary illustration of arrows that directly or indirectly connect any one or more entities with any other one or more entities is merely illustrative for ease of understand, and it is understood that such connectivity is wireless and may be through the Internet/Network 104.

As illustrated in FIG. 1F, the present invention provides for secure processing of non-physical monetary (including virtual funds) transactions, such as credit card and debit card transactions, utilizing coded data transmitted via mobile internet device 108 rather than the use and handling of physical plastic credit/debit or other forms of account cards. The WTPS platform 140 utilization consists of a separate outside service provider (containing one or more servers) serving as a “central” platform or “hub” for all communications and approvals. As stated above, the computer system(s) of the wireless transaction processing system platform 140 may comprise of one or more computers or servers in one or more locations. Accordingly, the term “central” or “hub” should not be construed as a single location or a single server, but may be defined as a center of activity, functionality, commerce, or transactions.

The WTPS 100 provides an independent “hub” for transactions and communications between many diverse entities. Accordingly, the WTPS 100 illustrated in FIG. 1F is independent of all entities and is non-specific to any, including any seller 102 and buyer 106. The WTPS 100 may be associated as an independent, self-contained, non-integral entity within a financial institution such as a credit issuing entity, credit network, or a merchant service provider. Maintaining the independence of WTPS 100 while associated with a financial institution enables the processing of any transaction for any account of any member buyer and member seller. For example, a buyer may have banking relationship with a first bank, a seller may have a banking relationship with a second bank, the third party processor may be a third bank, and the WTPS 100 may be associated with a fourth bank. In this instance, a member buyer 106 and a member seller 102 of the WTPS 100 may seamlessly execute full transactions, regardless of associations.

In the exemplary embodiment illustrated in FIG. 1F, the WTPS 100 can handle all transactions (e.g., transactions using credit/debit cards or virtual funds). The WTPS 100 eliminates the use of all other third party processors 227 and instead relies on its own internal processing to handle such transactions. However, as illustrated in FIG. 1F, the WTPS 100 may also optionally have association with individual third party processors 227, which can facilitate cashless transactions.

The overall transaction system illustrated in FIG. 1F includes at least one credit issuing entity 103 that issues credit/debit cards to consumers and businesses. It should be noted that it is only for clarity and convenience of example that a single box is used to illustrate one or more credit issuing entities. A non-limiting example of credit issuing entity may include a bank that issues credit card or a debit card to bank customers, including consumer and business customers. The credit/debit card network 105 is network of credit/debit card companies. Non-limiting examples of companies that constitute the credit/debit card network may include Visa®, MasterCard®, and so on. A third party processor 227 is an entity that is established to store, process, or transmit credit/debit transactions for merchants, which may include approval/denial of transactions. A non-limiting example of a third party processor 227 may be a merchant bank that functions as a merchant service provider (e.g., providing a merchant account to seller 102 for enabling the seller 102 to accept card-based transactions). It should be noted that the credit issuing entity 103 and the third party processor 227 may be two separate divisions or departments of the same institution such as a bank or may be two separate institutions. For example, the credit issuing entity 103 may be a bank that issues a credit card to a consumer, and when the card is used by the consumer to purchase a product, a different division of the same issuing bank may act as a third party processor to deny the transaction, which means that the transaction was not approved by the card issuer.

As stated above, after a buyer 106 becomes a registered member of the WTPS 100 (e.g., via the WTPS website), a mobile app (or a mobile application) of the wireless transaction processing system is downloaded to the mobile Internet device 108 (such as a mobile phone) of the buyer 106, where the buyer 106 and the mobile Internet device 108 are associated and enabled to communicate via 115 with the WTPS 100. It should be noted that the WTPS app may readily be downloaded into a mobile internet device 108 without prior registration, after which, the end-user may easily register with the WTPS via the mobile app. The registration with the WTPS 100 enables the buyer 106 to associate any issued credit accounts from any one or more credit issuing entities 103 via communication 123 with the WTPS account of the buyer 106. The wireless transaction processing system application for the mobile device (hereinafter referred to as “WTPS app”) may be launched via the mobile Internet device 108 to enable a user (e.g., buyer 106) access to the WTPS user account. As illustrated, the buyer 106 may select the desired items from the exemplary convenience store or seller 102 for purchase (e.g., a bag of groceries), with the registered seller 102 generating a transaction data 202 (which includes the seller 102 WTPS ID, but no private or confidential information) for the buyer 106 for the selected goods and or services.

When a registered buyer 106 makes a purchase from the registered seller 102 using the mobile Internet device 108, that information is communicated via 115 to the WTPS 100, which, in turn, may optionally communicate the information via communication 121 to the optional third party processor 227. Regardless, either WTPS 100 or the third party processor 227 forward a request (indicated by communication 111/113) to the credit/debit card network 105 regarding the purchase amount, and the credit/debit card network 105 determines the balance of credited amount available for use by the buyer 106, and reports back to the WTPS 100 (or optionally, the third party processor 227) via communication 111/113. Thereafter, based upon the availability of credit, the transaction is either approved or denied by WTPS 100 (or optionally, the third party processor 227), with results reported (via communications 115 and 117) from the WTPS 100 to the buyer 106 and or seller 102 or to seller 102 via communication 119 by the third party processor 227. It should be noted that in some instances WTPS 100 may handle all reporting. That is, instead of the third party processor 227 reporting the authorization results directly to the seller 102 via communication 119 that the buyer 106 is approved (or denied credit), the third party processor 227 may instead handle all work and simply report the authorization results to the WTPS 100 via communication 121 for distribution by WTPS 100 via communications 115 and 117 to respective buyer 106 and seller 102. After the transaction is complete, the credit account of the buyer 106 is debited by the purchase amount and the account of the seller 102 is credited by the same amount, and the respective accounts of the buyer 106 and seller 102 are updated in all entities involved in the transaction.

FIGS. 2A to 2L are exemplary flowchart illustrations of the details of the wireless transaction processing system in accordance with the present invention. As illustrated in FIG. 2A, with the WTPS 100 of the present invention, a buyer 106 that is a member of the WTPS 100 may walk into a convenient store 102 that is also a member of the WTPS 100 without carrying any cash or credit cards, purchase the desired products of the seller 102, and complete a transaction for purchase of the products using the mobile Internet enabled device 108. The seller 102 is not required to have any specialized equipment, and no confidential information is exchanged between the seller 102 and the member buyer 106. The buyer 106 may select the desired items from the exemplary convenient store 102 for purchase (e.g., a bag of groceries), with the seller 102 generating a transaction data 202 (which includes the seller 102 WTPS ID) for the buyer 106 for the selected goods and or services. As described above, the transaction data 202 has no confidential or private information.

As further illustrated in FIG. 2A, in order to commence transaction using the WTPS 100 of the present invention, the buyer 106 must launch the WTPS app 190 using the mobile Internet device 108 (operational functional act 204). The launching operation 204 of the WTPS app 190 from the mobile Internet device 108 may immediately transmit location information 206 (via a typical GPS system) of the mobile Internet device 108 to the WTPS platform 140 through the operational functional act 210, and initiates an access protocol 208. Alternatively, the launch operation 204 of the WTPS app 190 may simply initiate the access protocol 208 only, without an immediate transmission of location information 206 prior to authorized access. After the launch operation 204 of the WTPS app 190, the access protocol 208 using a graphic user interface (GUI) enables the authorized user to enter appropriate authorization code such as a password to allow access to the WTPS user account. It should be noted that WTPS 100 may provide users with may different types of access codes. Non-limiting examples of which may include a user generated password that may enable a user to fully access all features of WTPS user account, an access code for limited access to WTPS user account (for example, to enable view of history of transactions only), or an access code that would activate emergency system protocols (e.g., the user is forced (by thief) to access the WTPS account to transfer funds). Accordingly, entrance to the WTPS app is guarded by a unique per user access code (pin code). This safeguard allows only an authorized person to have access to the payment application. Repeated incorrect entry of the pin code may result in the application being locked and prevent usage until the consumer can contact WTPS and verify identify.

Assuming an access code (or pin) is correctly entered, the access protocol 208, through the operational functional act 210 provides the WTPS platform 140 with the consumer or buyer 106 identification information (buyer WTPS ID or buyer-ID) and buyer physical location via a typical GPS system. The WTPS platform 140 received that information via the operational functional act 212, and upon verification via the operational functional act 214 approves access to the WTPS app 190 to launch a main screen or main page at the operational functional act 216 on the I/O module 160 of the mobile Internet device 108.

In general, the WTPS system includes a GPS Positioning Log. At the time of the transaction, the WTPS saves a record of the GPS data for users, cross-referencing time with the GPS location and a generated WTPS transaction reference ID number (detailed below). This accumulated data is used as a security measure (detailed below) to ensure that the users are making the actual purchase in case of later transaction issues. Additionally, the GPS record for the transaction may be used to determine applicable merchant or transaction fees.

As illustrated in FIGS. 2A, 2G, and 2L, the verification operational functional act 214 to verify user 106 and the mobile Internet device 108 (e.g., a handheld device information) by the WTPS 100 includes the operational functional act 218, which, as illustrated in FIG. 2G, includes determining if the GPS location of the mobile Internet device 108 has been included in the transmitted information via the operational functional act 210. If the WTPS 100 determines that the GPS location is not included in the transmission operational functional act 210, the WTPS 100 requests GPS location from a GPS provider via the operational functional act 220. Otherwise, if the WTPS 100 determines that the GPS location is included, the system 100 verifies user and handheld (e.g., device 108) information, including location of the device 108 via the operational functional act 222.

As detailed in the exemplary flowchart of FIG. 2L, the verification process of the operational functional act 214 includes the operational functional act 224, which determines if the device 108 information (device signal-ID) is correct, and if so, it verifies the access code type at the operational functional act 434. If the WTPS determines at the operational functional act 436 that the access code type is an optionally available emergency access code, then the WTPS 100 activates emergency system protocols at the operational functional act 438, which may include a variety of functions non-limiting, non-exhaustive examples of which may include completing the transaction for the safety of the user (or zeroing all account balances listed on the WTPS app 190 of the mobile Internet device) and automatically notifying proper authorities with respect to the location of the user (e.g., transmit request for emergency assistance to the location of the user).

If the WTPS 100 determines that the access code is not an emergency access code, then WTPS 100 determines if the access code is an authorized access code at the operational functional act 440. If it is determined that the access code is an authorization access code, then the WTPS 100 determines if WTPS user account is active (at the operational functional act 226), for example, has the account be canceled, mobile Internet device reported as stolen or lost, and so on. The determinations in the operational functional acts 224 and 226 may be accomplished by numerous methods, a non-limiting example of which may including the use of relational data base systems that easily compare the stored registration information of users (e.g., sellers and buyers) and their device information with incoming information via the operational functional act 210 (FIG. 2A).

As further illustrate in FIG. 2L, the WTPS 100 also determines if there is a duplicate device identifier signal from another device at the operational functional act 228. A duplicate device identifier signal may be generated, for example, by cloning a mobile Internet device. For example, a first user with original mobile Internet device in location “A” may request access to WTPS 100 at a first time interval, while a second user with a duplicate identifier signal (e.g., using a clone mobile Internet device) may request access to the WTPS 100 in location “B” simultaneously or at a subsequent improbable second time period. This creates conflict in location (known as “location hopping”) of the mobile Internet device because a physical object cannot exist in two places. That is, the WTPS 100 “sees” the same phone (due to identical device signal identifiers) in two different geographic locations “A” and “B”. In such an instance, the operational functional act 228 based on the duplicate device signal identifier from two locations “A” and “B” will prevent both the first and the second users from accessing the WTPS 100 by terminating all further processing for both devices. This prevents a would be thief from stealing a device identifier signal (device signal-ID) of an original mobile Internet device and using that original device signal-ID to access WTPS 100 by a cloned version to access another person's WTPS user account to commence unauthorized transaction. It should be noted that the use of GPS or similar location identifier systems to access and use the WTPS 100 of the present invention is also used to verify that the consumer was at a particular location for purchase of goods and services from a seller.

Referring back to FIG. 2A, after authorized access by the buyer 106, the WTPS app within the mobile Internet device 108 displays the main page or start screen through the operational functional act 216 (via connector 203 in FIGS. 2L and 2A) where the user 106 may perform a variety of functions. Non-limiting examples of functions enabled may include modifying settings of the WTPS user account through the operational functional act 230, start of a transaction (operational function act 232), preview of account history (operational functional act 236), selecting an account associated with the WTPS user accounts (operational functional act 234) to perform a variety of functions associated with the selected account, or performance of other functions such as accessing loyalty systems (operational functional act 238).

The present invention provides capabilities that enable a user to access the above-mentioned functionalities in a variety of manner. As illustrated in FIGS. 2A and 2B, the user may first select a specific account via the select account operational act 234 of FIG. 2A, and then select an action 241 of FIG. 2B (via the connector 205 between FIGS. 2A and 2B) to perform a function on that particularly selected account. For example, a user may first select an account via the operational functional act 234 of FIG. 2A (e.g., a business credit card account), and then select an action via the operational functional act 241, such as preview history of the selected account by the operational functional act 236 of FIG. 2B. As best illustrated in FIG. 2F, the select account module 234 enables a user to select any one or more specific accounts to perform a variety of tasks on the selected account. As another example, the user may first select an account via the operational functional act 234 of FIG. 2A (e.g., a personal debit card account), and then select an action 241 such as settings modifications by the operational functional act 230 of FIG. 2B for the selected account. As further illustrated, the user may also select an account via the operational functional act 234 of FIG. 2A (e.g., a bank checking account), and then select an action 241 such as starting a transaction by the operational functional act 232 of FIG. 2B using the selected bank checking account. Accordingly, from the main or start screen operational functional act 216 a user may simply select an account via the operational functional act 234 of FIG. 2A, and then select an action 241 in FIG. 2B that the user desires to perform in relation to the selected account.

Alternatively, the user may first select any of the above mentioned specific actions or functions, for example, from the main page or start screen 216, the user may select start of a transaction (operational function act 232 of FIG. 2A), preview of account history (operational functional act 236 of FIG. 2A), or performance of other functions (operational functional act 238 of FIG. 2A), and then optionally select an account via the operational functional act 234 of FIG. 2B to perform the selected function on that selected account.

As indicated above, the settings operational functional act 230 may be accessed via the main screen 216 (FIG. 2A) or, alternatively, after the selection of an account via the operational functional act 234 of FIG. 2A, with the user directed to the settings operational functional act 230 of FIG. 2B (via connector 205 and select action operational functional act 241). Using the settings operational functional act 230 (FIG. 2A or FIG. 2B) to modify WTPS user account settings (via the settings module 230, best illustrated in FIG. 2H) a user may set or modify WTPS user accounting settings in a variety of ways through the WTPS app 190, including (as best illustrated in FIG. 2H) modifying display language and overall layout for the mobile application via the operational functional act 240, associating or reassigning nicknames to various registered accounts such as a bank, credit or debit card account with the WTPS user account via the operational functional act 242. In addition, the operational functional act 242 enables users to prioritize and set as default certain accounts that the user uses the most. Other non-limiting examples of settings may include currency converters that may be set via the operational functional act 244, which convert currency in one denomination (e.g., when using the direct fund transfer of the present invention) to other denominations, if need be. Other settings feature via the operational functional act 246 may include deletion of WTPS app 190 and all related data from Mobile device, or blocking access to an individual account from the mobile device.

As further indicated above, the preview history operational functional act 236 may be accessed via the main screen 216 (FIG. 2A) or, alternatively, after the selection of an account via the operational functional act 234 of FIG. 2A, with the user directed to the preview history operational functional act 236 of FIG. 2B (via connector 205 and select action operational functional act 241). Using the preview history operational functional act 236 to preview account history (preview history module is illustrated in FIG. 2I), a user may view most recent transactions via the operational functional act 250, search and view transactions based on a variety of different search criteria via the operational functional act 252, or perform other functions related to view of account history via the operational functional act 256. For example, operational functional act 256 may be a mode setting operation in which a user may set a mode that WTPS app 190 preview account history in a limited time frame for all transactions (e.g., within the last 30 days only), which would expedite processing of the account history request on the mobile Internet device 108. In general, the account history module (FIG. 2I) may display seller information (e.g., seller name, location, etc.), date of transaction, the amount, or any other information relevant to account history or transactions. As with most other accounting GUIs, a user can drill down to view further account details by selecting a specific account, date, or other parameter to view further details of a particular transaction.

As further indicated above, the start transaction operational functional act 232 may be accessed via the main screen 216 (FIG. 2A) or, alternatively, after the selection of an account via the operational functional act 234 of FIG. 2A, with the user directed to the start transaction operational functional act 232 of FIG. 2B (via connector 205 and select action operational functional act 241). The start transaction operational functional act 232 enables a user (e.g., a buyer 106) to commence a desired transaction to purchase, transfer funds, pay bills, or execute other transactional functions. Through the start transaction 232 the consumer can provide disbursement of funds from a desired account (which was associated with the WTPS user account) for the purchase of desired products of a seller 102. As best illustrated in FIG. 2B, the start transaction operational functional act 232 initiates a disbursement protocol 270, enabling the buyer 106 to select (via the operational functional act 272) various interaction protocols, including purchase 274, direct fund transfer 276, bill-payment 278, or other transactional protocols 280. The bill-payment 278 is very similar to known online bill payment systems, with the exception that funds to pay bills are paid through the various personal accounts (e.g., business credit card, bank checking account, etc.) of the user that are associated with the WTPS user account.

As illustrated in FIG. 2B, selection of purchase operational functional act 274 enables the buyer 106 to purchase a product and or service from a seller. Upon selection of the purchase operational functional act 274, the mobile Internet device 108 of the buyer 106 initiates a receive data operational functional act 282 (assuming an account has been selected by the select account 234). FIGS. 2J and 2K are non-limiting examples of implementing the receive data operational functional act 282. FIG. 2J is an exemplary flowchart comprised of operational functional acts that enable reception of transaction data 202 (associated with the seller and seller goods and or services) as an image, and FIG. 2K is an exemplary flowchart comprised of operational functional acts that enable reception of the transaction data 202 (associated with the seller and seller goods and or services) as a wireless signal.

It should be noted that the seller 102 may transmit the transaction data 202 by any means, non-limiting, non-exhaustive listing of examples of which may include data packets and bar codes (e.g., QR codes), file download, screen shot, or to the seller mobile Internet device using traditional mobile protocols such as Short Message Service (SMS), Multimedia Message Service (MMS), or e-mail, etc. Therefore, the examples provided in the flowcharts of FIGS. 2J and 2K should not be limiting. For example, if the transaction data 202 is transmitted to a mobile Internet device 108 using traditional SMS or MMS, then the buyer 106 must provide the seller 102 with that device's mobile phone number to enable the seller 102 to forward the transaction data 202. Again, no confidential or private information is exchanged and the transaction data 202 transmitted has (at the very least) information that is found in a typical conventional receipt, with the addition of GPS and any other information desired to complete a transaction in accordance with the present invention. For example, for online transactions, the transaction data 202 may also include information that indicates that the transaction is an online transaction.

Referring to FIG. 2J, upon activation of the purchase protocol operational functional act 274, the receive data operational functional act 282 is initiated, which launches the data-image reception protocol 284 to activate an image capturing mechanism 172 such as a camera on the mobile Internet device 108 using the operational functional act 288, and receive a coded-data image via the operational functional act 237. As detailed below, the coded data-image is an image of a machine-readable representation of the data 202 associated with the seller and the desired goods and or services of interest to consumer. In general, each seller 102 (and their goods and or services) is associated with a transaction data 202 that has a machine-readable representation. For online purchases, buyer 106 elects to pay with WTPS during the checkout phase of an e-commerce online purchase. At which point, the buyer 106 is presented with a WTPS coded-data image relating to the transaction. The generation of the WTPS coded-data image may occur on a separate online website page displaying the coded-data image or may be displayed inline within the e-commerce checkout page. It should be noted that WTPS coded-data image may be displayed in a variety of methods and that the above-disclosed displaying methods should not be limiting.

Non-limiting, non-exhaustive listing of examples of machine readable coded-data image of data 202 associated with seller 102 and its goods and or services may include well-known barcodes, Quick Response (or QR) codes, or other types of codes, including the actual numerical value of the codes, an image of which may be printed on a receipt or displayed on a website page and captured by a camera. A QR code is a very well known matrix (or two dimensional) barcode, which is a machine-readable representation of data. Both QR code generator applications and QR code reader applications for wireless devices are also well-known and can easily be downloaded from a vast variety of web sources (mostly free of charge), similar to the manner of downloading a free Portable Document File (PDF) generator and reader. In fact, most mobile Internet devices 108 such as mobile phones may have a QR code reader application pre-installed.

Referring back to FIG. 2J, after receiving the data-image, it is processed by the process coded data image operational functional act 290, which displays the data to validate the seller on the I/O module 160 of the mobile Internet device 108, including all information available with the capture data-image such as purchase amount, date, or any other information found on a conventional or point-of-sale receipt. Accordingly, transaction data 202 is a transactional data print out with a QR code printed thereon, which is captured (or photographed) by the mobile Internet device camera 172, with no confidential or private information exchanged between seller and buyer. That is, the QR code or any other code generated by the seller has no confidential or private information.

As indicated above, FIG. 2K is an exemplary flowchart comprised of operational functional acts that enable reception of transaction data 202 as a wireless signal, rather than a coded data-image. As illustrated, upon activation of the purchase protocol operational functional act 274, the receive data operational functional act 282 is initiated, which launches the data reception protocol 286 to activate the transceiver module or to resource mobile messaging system 170 of the mobile Internet device 108 using the operational functional act 292 to wirelessly receive coded-data by the operational functional act 294. The coded-data is a machine-readable representation of transaction data 202 associated with the seller and the desired goods and or services of interest to consumer. As indicated above, the seller may transmit the transaction data 202 by any means.

Non-limiting, non-exhaustive listing of examples of information that may be included in the transaction data 202 associated with the seller 102 are numerous and may include, among others such as the seller 102 WTPS ID, the transaction types (e.g., online, physical, remote or loyalty, (either virtual or real) transaction), seller information such as business name, GPS location of business, physical address of the business, merchant service provider information (if needed), e-commerce information, website address (e.g., domain name for online merchant for online transactions), account information (in relation to the account created when the seller 102 registered to become a member of the WTPS 100), and so on. Other non-limiting, non-exhaustive listing of examples of information that may be included in the data 202 associated with the seller 102 products may include information about an item being sold, including, but not limited to, for example, item (or service) serial number, price, and or any information that is printed on a typical or detailed receipt (e.g., invoice) of a transaction when the seller 102 inputs the item information into a typical cash register (or point-of-sale system) and prints a receipt or when a purchase is made online and a confirmation page is displayed on a webpage.

Regardless of how the transaction data 202 is transmitted and received, the received transaction data 202 is processed, enabling the transaction data 202 to be displayed by the I/O module 170 of the mobile Internet device 108 in accordance with the operational functional act 298 (FIG. 2C). The data displayed may contain any information desired that is related to the seller 102 and the goods or services being purchased, non-limiting examples of which may include physical location of the seller 102, or any other additional information, including those found on a receipt, itemized list, prices, taxes, invoice, seller point-of-sale transactional reference ID, authorization terminal transactional reference ID, server (i.e., waitress or waiter), and even table number (e.g., if seller is restaurant), cash register number, etc., or any other information that enables completion of transactions (online or otherwise) in accordance with the present invention, but with no confidential or private information exchanged.

As further illustrated in FIG. 2C, the display of the data via the I/O module 160 by the mobile Internet device 108 in accordance with the operational functional act 298 enables the buyer 106 to confirm the data related to the transaction by the operational functional act 207 and indicated whether the transaction is a deposit (e.g., a security deposit for a rental equipment) or an actual purchase. The buyer 106 may be requested to confirm seller information such as a seller-ID (WTPS-ID), GPS location, purchase amount, or any other information that enables confirmation of the transaction by the buyer 106. Upon confirmation of data by the operational functional act 207, the confirmed data, and buyer information (including buyer 106 GPS) is transmitted via the operational functional act 209, and received by the WTPS platform 140 by the operational functional act 211. As indicated above, at the confirmation stage 207, the buyer may also select whether the transaction is a mere deposit (such as a security deposit where funds may be verified and authorized, but no actual fund is transacted or transferred to seller) or a normal purchase. This enables a user to use funds from an account associated with the WTPS 100 as mere deposit. For example, this option may be used when renting a product where the seller 102 may require a security deposit. Non-limiting examples of buyer information may include transmitting of buyer GPS location again, and any other relevant information. It is imperative to note that at no time is there any exchange of private or confidential information between a seller 102 and a buyer 106. In other words, no confidential or private information is exchanged between seller 102 and buyer 106. For example, with conventional transactions, a buyer hands out a credit card to a seller, which includes the confidential information such as a credit card number, expiration data, and the name of the cardholder. With the present invention neither the seller 102 nor the buyer 108 exchange any confidential information, and all exchanged information may optionally be encrypted.

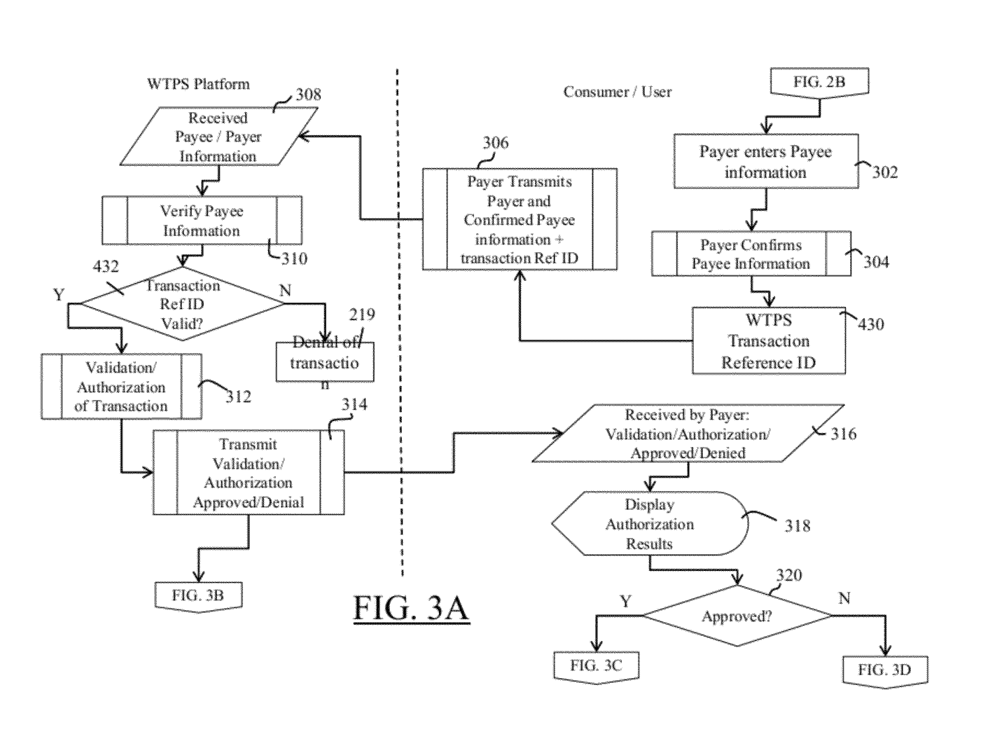

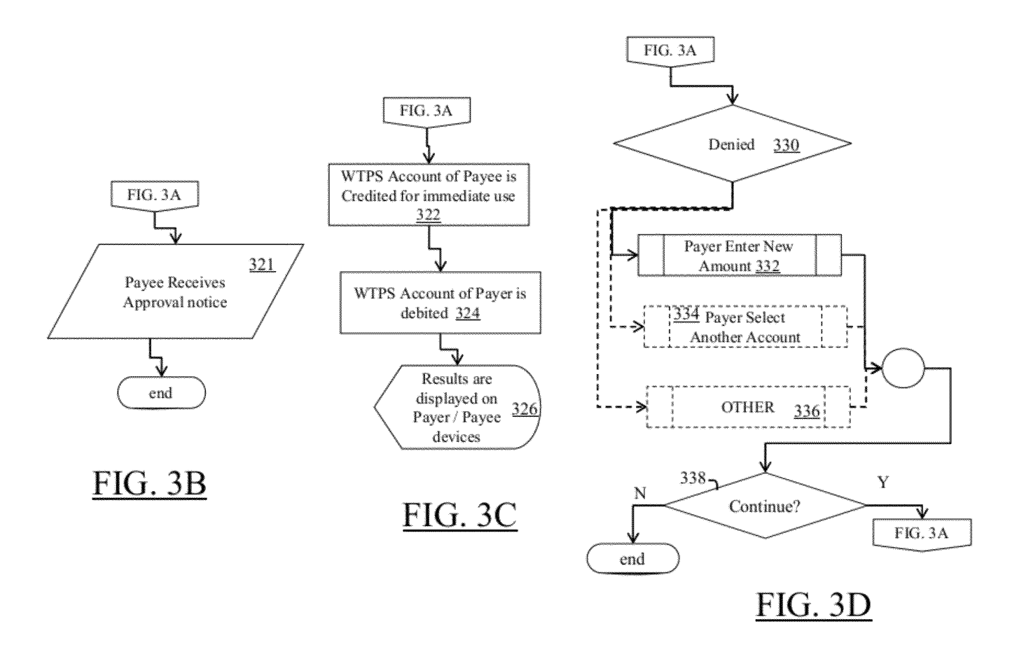

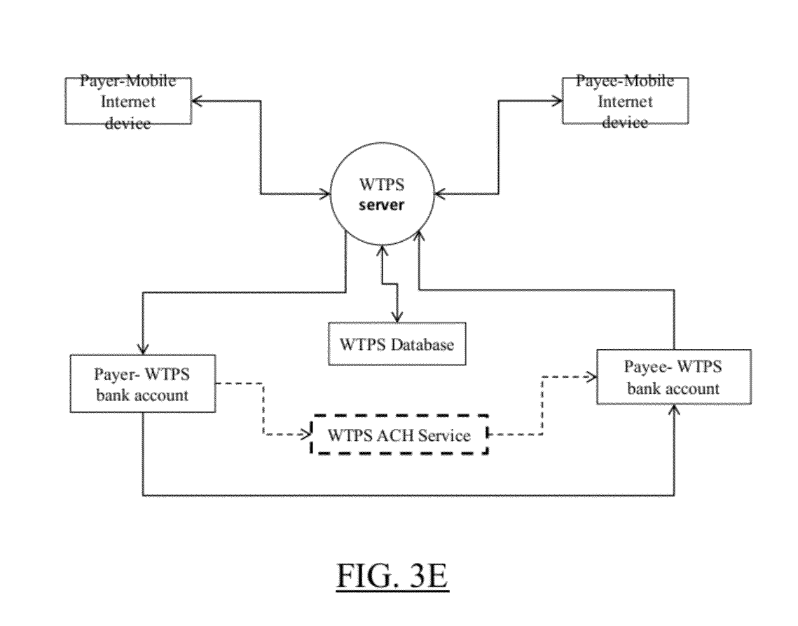

Referring back to FIG. 2C, upon confirmation (at operation 207), at operational functional act 430 a unique WTPS transaction reference ID or a tracking identification association with a transaction is generated, this WTPS transaction reference ID is generated for every transaction, including those involving mere deposits or just transfer of funds (FIGS. 3A to 3D). The WTPS transaction reference ID may be thought of as an in-system (or internal) reference identification used to track and identify any individual transaction, including deposits, purchases, transfers of funds, etc. Therefore, every transaction will have a unique WTPS transaction reference identifier, with the reference transaction identifier used (as a reference) to access any transaction that is associated with the reference identifier. It should be noted that the WTPS transaction reference ID generated is unique for the particular mobile Internet device 108 of a user, and may be generated by a wide variety of different types of algorithms. As a non-limiting example, the reference identifier for a transaction may be a simple sequential number that is generated within and for the particular mobile Internet device 108 every time the user makes a transaction (purchase, transfer of funds, deposit, or any other), which may also include the user mobile number. Therefore, the WTPS transaction reference ID is a dynamically generated unique user transaction ID created by the WTPS app and is transmitted to the WTPS primary server at the time of transaction. The WTPS primary server also dynamically generates an WTPS transaction reference ID and compares that to that which is being received from the WTPS app transmission. If the two WTPS transaction IDs match, then the transaction continues, if they do not, then the WTPS server locks the WTPS app in the mobile Internet device 108 and transmits a message to the user (e.g., buyer 106) to contact customer service.

As stated above, upon confirmation of data by the operational functional act 207, and generation of the WTPS transaction reference ID at the operational functional act 430, the confirmed data, WTPS transaction reference ID, and buyer information (e.g., buyer GPS) is transmitted via the operational functional act 209, and received by the WTPS platform 140 by the operational functional act 211. As indicated above, the WTPS system includes a GPS Positioning Log. At this point of the transaction, the WTPS saves a record of the GPS data for the transaction, cross-referencing time with the GPS location and a generated WTPS transaction reference ID number (generated by both the mobile Internet device and WTPS platform). This accumulated data is used as a security measure to ensure that the users are making the actual purchase in case of later transaction issues. Additionally, the GPS record for the transaction can be used to determine applicable merchant fees. It should be noted that the physical location of a seller 102 (such as a merchant) may not be required to be transmitted since the seller location may form a part of the seller 102 WTPS ID, when the seller 102 registers with the WTPS, providing the location of the business.

The received data, reference ID, and buyer information by the WTPS platform 140 (including buyer 106 GPS) via the operational functional act 211 is then processed by the operational functional acts 213 and 215. The process at 213 may include simply verifying the transaction data 202 transmitted by the seller 102. In this embodiment, it may also include verifying that the seller 102 is a legitimate member of the WTPS system 100 by checking the instant received information at operational functional act 211 against stored registration information of the seller 102, similar to the manner illustrated in FIG. 2L where the buyer 106 is verified.

The operational functional act 215 determines the seller location and mobile location of the buyer. Upon the determinations at the operational functional acts 213 and 215, at the operational functional act 432, the WTPS determines if the WTPS transaction reference ID is valid. The validity of the WTPS transaction reference ID may be determined by a variety of methods, which may depend upon the algorithm used to generate the reference IDs. As a non-limiting example, if the WTPS transaction reference ID is generated as a sequential number, and the WTPS platform determines that the transaction reference ID is out of sequence, then the entire transaction is simply denied, and the WTPS user account holder is notified. This scenario is likely if the original mobile Internet device has been cloned, hijacked, counter-fitted or intercepted. For example, the WTPS of the original mobile device may have generated WTPS transaction reference ID with a sequence number 0005 for a particular transaction, with the next subsequent number to be 0006. As stated above, the WTPS transaction reference ID is a unique identifier associated with and generated by the WTPS app 190 of the particular mobile Internet device. Therefore, the cloned mobile Internet device will commence its WTPS transaction reference ID at a number (or other identifier) when the original phone was cloned, which may have been at sequence number 0003. In such an exemplary instance, the sequence of the WTPS transaction reference ID for the original mobile Internet device is at 0006, but the WTPS app of the cloned mobile Internet device will generate the WTPS transaction reference ID starting at the sequence 0004 (which has already been used once by the original mobile Internet device). This is similar to two individuals writing checks from the same account, but the check number sequences do not match. The user of the original checks is on check number 0110, with check numbers 0100 to 0109 already cleared, and the other user using copied checks that start with copied check number 0107 writes a check with check number 0107 or 0108.

It should be noted that the use of GPS or similar location identifier systems to access and use the WTPS 100 of the present invention is intended to register and log that the consumer was at a particular location for purchase of goods and services from a seller. As an optional process and as illustrated in FIG. 2C, upon validation of the WTPS transaction reference ID at the operational functional act 432, the optional operational functional act 217 enables the WTPS system 100 to determine if the buyer 106 is in the same physical location as the seller 102. If buyer 106 and the seller 102 are not in the same location, then at the operational functional act 702, WTPS 100 determines if the transaction is an online transaction (via the information from the transaction data 202 or input by the buyer 106). If the transaction is not an online transaction, then the authorization for the transaction may optionally be denied at the operational functional act 219, and a possible denial of service is optionally transmitted to the buyer 106 via the operational functional act 221, where it is received by the operational functional act 223 of the WTPS app 190, and displayed by the I/O module 160 of the mobile Internet device 108 of the buyer 106.

As further indicated in the operational functional act 217, if WTPS system 100 determines that the buyer 106 is in the same physical location as the seller 102 or that the transaction is an online transaction (operational functional act 702), then at the operational functional act 704 the WTPS system 100 commences validation protocol 704. That is, all verified information is processed and validated by the operational functional act 704. Thereafter, at the operational functional act 225, the WTPS 100 commences authorization of the transaction. In other words, as indicated by the flowchart of FIG. 2C, WTPS 100 may both verify users (buyers, sellers, and so on) 704 and authorize transaction or credit approval/denial 225 without any third party 227.

It should be noted that the authorization protocol may be accomplished by a third party processor 227, such as a bank or any other convention entity that processes credit, debit, or bank transactions. That is, information (such as buyer ID, buyer location information, and transaction data 202) that is to be verified may be verified by the operational functional act 704 of the WTPS 100 as illustrated, and a third party 227 executes authorization of transaction (or credit approval/denial) once verification by WTPS 100 has been completed. The authorization of the transaction by the third party 227 is then received by WTPS 100 through the operational fictional act 229, and transmitted via the operational functional act 221.

Non-limiting examples of verification and then authorization may include verifying availability of funds in the selected account of the buyer for the selected transactions, limits or restrictions placed on the buyer account, or any other information that would cause termination or approval of the purchase, similar to the conventional manner that a credit card account of a buyer is verified and then authorized (e.g., approved or denied) for a particular transaction.

FIG. 2D is an exemplary flowchart that illustrated the receiving of verification and authorization by the seller and FIG. 2E is an exemplary flowchart that illustrated the receiving of verification and authorization by the buyer. As illustrated in FIG. 2D, the seller receives all information, including an optional previously uploaded portrait of the buyer at the operational functional act 233, and processes that information at the operational functional act 235. The portrait would function as a photo ID in a similar manner as those found printed on major credit cards. Accordingly, the seller would not only receive approval or denial of the transaction, but also a portrait of the buyer (as a safeguard). Therefore, even if the transaction is approved, if the portrait is a photo of an individual who is not the actual buyer, the seller could simply terminate the transaction. With respect to FIG. 2E, the buyer receives the validation, and merely discloses that information to the seller, where at the operational functional act 237, the seller receives that information from the buyer. Regardless of the entity that executes the authorization protocol, the WTPS platform 140 may optionally transmit the authorization to one or both the buyer 106 and seller 102. It should be noted that if the transaction type is mere deposit indicated in the operational functional act 207 (e.g., security deposit for rental of equipment), then all funds may be “authorized” with no actual transfer of funds.

As an added security measure, the present invention further provides an optional travel itinerary module (FIGS. 2M and 2N), which optionally uses the GPS data and consumer reported travel itinerary to potentially enable or disable further processing of a transaction. That is, the travel itinerary module of the WTPS may optionally maintain a log of GPS and travel itinerary (voluntarily provided by users prior to any travel), to determine if a current transaction should continue to be processed base upon the current location of the user as compared with the submitted travel itinerary. The travel itinerary module facilitates verification of buyer location in view of credit card company policies that may freeze an account if the account is used outside of its normal area (also known as “out of the norm spending habit”).

The GUI for a travel itinerary is part of the travel itinerary module of the WTPS app, and may be accessed in a variety of manner, such as the selection of operational functional act 238 (FIGS. 2A and 2B). In other words, after the launch of the WTPS app, the user may simply select the travel itinerary module through the settings 230 (FIG. 2A) to launch it and complete the travel itinerary GUI and transmit it to WTPS. The travel itinerary GUI may include the usual information related to time and date of travel, or any other travel related information (similar to input of information to purchase an airline ticket) that may be used by the WTPS or passed on to the actual financial entity (such as a credit card issuing bank) to prevent the freezing of the user account. If a buyer 106 does not provide the travel itinerary to WTPS, the processing of the transaction (outside the “normal habit” of a buyer 106) may proceed by the WTPS with a warning “flag,” and the credit card issuing bank may be provided with the flagged transaction. Thereafter, it would be up to the credit issuing bank to make a determination to freeze the credit card account selected by the buyer 106 through the WTPS app to purchase a product or service. On the other hand, if a buyer 106 does provide the travel itinerary to WTPS, the processing of the transaction (outside the “normal habit” of a buyer 106) may proceed by the WTPS with a no warning “flag,” but the credit card issuing bank may still freeze the account used by the buyer 106 through the WTPS app if WTPS travel itinerary is not communicated with the bank (for example, the bank has no agreement with WTPS to provide such information). In such a scenario, the bank may contact the WTPS administrator to determine if the buyer 106 provided any travel notification to the WTPS. Regardless, it would ultimately be up to the credit issuing bank to make a final determination to freeze or not freeze the credit card account selected by the buyer 106 through the WTPS app to purchase a product or service. Accordingly, a WTPS logged travel itinerary may or may not be used by the credit issuing bank and it is only a notification means to be provided to the credit issuing bank as an added tool for their use, without an affect on the WTPS operations. The WTPS logged travel itinerary may also be used as marketing tool for targeting ads directed to buyers 106 or sellers 102 (the airlines).

FIGS. 3A to 3D are exemplary flowcharts illustrating a process of transfer of funds from one individual or entity to another individual or entity using the wireless transaction processing system in accordance with the present invention. The selection of direct transfer operational functional act 276 (illustrated in FIGS. 2A and 2B) enables member payer of the WTPS 100 with a mobile Internet device 108 to initiate a direct transfer of funds to a member payee of the WTPS 100 that also has a mobile Internet device 108.

As illustrated, the member payer accesses the wireless transaction processing system by the mobile Internet device 108 as described above in relation to FIGS. 2A to 2L, and is directed to the direct transfer operational functional act 276, and selects the desired available account from which the payer is to provide a disbursement for the direct transfer of funds to the payee. As best illustrated in FIG. 3A, the selection of the direct transfer operational functional act 276 initiates a GUI at the operational functional act 302 that would enable the payer to enter the receiver of the funds to be transferred. That is, the payer enters the payee information, including the amount of transfer of funds (real or virtual—to be detailed below in relation to FIG. 3E) in the operational functional act 302, and confirms the entered data or information at the operational functional act 304, where upon confirmation, a WTPS transaction reference ID 430 is generated by the WTPS app 190, with all information transmitted to the WTPS platform 140. That is, the WTPS app 190 of the mobile Internet device 108 transmits both the payer information and confirmed payee information, including the WTPS transaction reference ID 430 to the WTPS platform 140 via the operational functional act 306. The function and use of the WTPS transaction reference ID 430 is detailed above in relation to FIG. 2C. It should be noted that the payee does not initiate the disclosed transaction.

As further illustrated, the WTPS 140 received the transmitted information at the operational functional act 308, with WTPS 100 verifying member payee information at the operational functional act 310, including checking the WTPS transaction reference ID. If WTPS transaction reference ID is not valid, the entire procedure is denied and the process terminated at the operational functional act 219, otherwise, the WTPS 100 further executes validation and authorization protocols for the transaction (assuming the WTPS transaction reference ID is valid) at the operational functional act 312, and transmits results via the operational functional act 314 to payer and the payee. As further illustrated, the payer receives the validation and authorization at the operational functional act 316, where WTPS app 190 displays the results to the payer via the operational functional act 318.

As illustrated in FIG. 3B, the payee receives approval (if any) results at the operational functional act 321. If at the operational functional act 320 (FIG. 3A) the direct transfer of fund is approved (validated and authorized), the WTPS 100 credits the payee account at the operational functional act 322 (FIG. 3C), and WTPS 100 debits the payer account at the operational functional act 324, and displays the respective results for respective payer and payee at the operational functional act 326. That is, the payer views that the account of the payee has been credited by the transfer amount.

Referring back to FIG. 3A, if the authorization results in denial (not approved) in the operational functional acts 320, then as illustrated in FIG. 3C, several choices is presented to the payer. That is, if transfer is denied (operational functional act 330), payer may enter a new amount (at the operational functional act 332), or optionally select another account from which to transfer funds at the operational functional act 334, or optionally perform other functions such as reschedule the same transfer to a later date at the operational functional act 336 (where funds may be available at some future date) or optionally transfer funds from another account to the selected account which the payer wishes to continue to use. The payer may then select to continue at the operational functional act 338 or terminate the entire process. Accordingly, as with purchasing a product, no private or confidential information is exchanged during the fund transfer. It should be noted that the transferred funds may be available for immediate use, which depends on the financial institutions policies that hold the accounts of the users despite the fact that WTPS may credit the account of the payee immediately. For example, the WTPS may immediately credit the account of the payee and debit the account of the payer, but the banks that hold the accounts of the payee/payer may not release the actual funds immediately (for example, they may require an Automated Clearing House or ACH transfer). It should be noted that in general, it is preferred that for certain instances that the payee first agree to the transfer of funds and accept the transfer, prior to the transaction being finalized. That way, the payee transmits an acceptance to the WTPS server to continue the process. If the payee denies the transfer (i.e., does not accept the transaction to be finalized), then a notice is transmitted to WTPS server to notify the payer mobile Internet device and terminate the transfer.

FIG. 3E is a non-limiting, exemplary illustration of another embodiment of an overall systems overview of direct, user to user fund transfer in accordance with the present invention. Although FIG. 3E is exemplarily described using virtual funds (detailed below) and virtual accounts (detailed below), the embodiment illustrated and described in FIG. 3E is equally applicable to real funds (real currency) and real accounts (of real currency). Various aspects and feature illustrated and described in FIGS. 3A to 3D are equally applicable with respect to the process flow shown in FIG. 3E. A virtual fund is a note or currency established by an entity that is only for use within that entity eco-system. That is, the virtual funds have no actual monetary value outside the entity eco-system that established the funds. Virtual funds or currencies are only honored within the environment within which they were established. Therefore, virtual money is a note that has a specific value, has a limited use within a specific environment, and is honored by the members or participants of that closed environment (or closed eco-system). Accordingly, the FIG. 3E illustrates a system wherein users may transfer virtual funds (virtual currency) to one another. Of course, the only place where the virtual funds may be redeemed is within the “system” or company that established the virtual currency. Non-limiting examples of virtual funds or virtual currency may be the U.S. government food stamps program (as a concept of virtual money), or airline points, etc. For example, food stamps (or Electronic Benefit Transfer (EBT) card) are established by the U.S. government and have monetary value only as a result of participating users and merchants that accepts foods stamps as a payment option for goods or services. As another example of virtual currency, the airline points offered by various airlines are only redeemable by the particular airline that issued the reward point. Food stamps or airline points have no monetary value with merchants or individuals that do not accept them as a payment option for products. Therefore, the only place where food stamps or airline points may be redeemed is within the system (U.S. government and all participants—users of food stamps and merchants or the specific airline and the individual flyers with that airline the accumulated the points). Accordingly, virtual currency or funds do have a monetary value (e.g., airline points may be redeemed for a plane ticket that has an actual dollar value), but only within the entity that established it.

Referring to FIG. 3E, the payer launches the WTPS app within the payer mobile Internet device and selects the option to transfer virtual funds (vs. real dollars) to another WTPS member (the payee). The payer forwards transfer and required information of the payee (similar to FIG. 3A) to the WTPS Primary Server. That is, the payer selects from their contact list available on their WTPS app to select the payee. The payer enters in the amount (virtual funds) they wish to transmit to the payee. The payer confirms the transfer transaction and transmits the transaction to the WTPS processing (WTPS server).

The received information from the payer is checked by the WTPS server against the WTPS customer database to verify available funds in payer WTPS virtual account. If or once the funds are available, then WTPS platform transmits a notice to the payee WTPS mobile app on the mobile Internet device to inform of and accept the proposed virtual fund transfer. It should be noted that the payee does not initiate the disclosed transaction. Once the payee accepts the transfer, the payee transmits an acceptance to the WTPS server to continue the process. Since it is a virtual currency that is being transferred (and not real dollars), the payee must be a participant and actual accept the virtual currency. If the payee denies the transfer, then a notice is transmitted to WTPS server to notify the payer mobile Internet device and terminate the transfer.

If the payee accepts the transfer, the WTPS server transmits the payer WTPS bank account to commence transfer of virtual funds to payee WTPS bank account. The transfer may or may not include an Automated Clearing House (ACH) service registered to an account with WTPS for fund transfer purposes between banking institutions. If the transfer is completed within the same bank then the process is internal to the bank's system and does not require an ACH transfer.

Once the transfer has been completed, the payee WTPS bank account transmits a confirmation to the WTPS server that the payer WTPS bank account has been credited and the payee WTPS bank account has been debited. The WTPS server updates the WTPS database for the newly adjusted balances of the payee and the payer, and notices are transmitted to the payer and the payee mobile Internet devices that the virtual money has been transferred and that the transferred funds are available to the payee.

It should be noted that if the payer does not have sufficient funds available in their WTPS virtual account, then they must first choose a credit account from the WTPS registered accounts and add virtual money to their virtual account from that credit or debit card account or from a reload purchase from a third party outside funding company (similar to the processing illustrated and described in relation to FIG. 3D). Further, if payee is not yet a member of WTPS, then a notice is transmitted to the payer mobile Internet device informing them that there is a money transfer (virtual money) pending and that they need to download and install the WTPS app onto their mobile device. Once the application is installed and the payee has created a WTPS use account, then transfer will proceed as outline above.

As has been described above, the WTPS 100 is a separate entity that functions as a “hub” between consumers (buyers 106 and sellers 102), credit issuing entities 103, card networks 105, and the optional third party processors 227 for processing cashless transactions. As described below, the present invention provides another embodiment wherein the WTPS 100 is integrated within an existing credit issuing entity and or a third party processor, rather than functioning as a standalone platform.

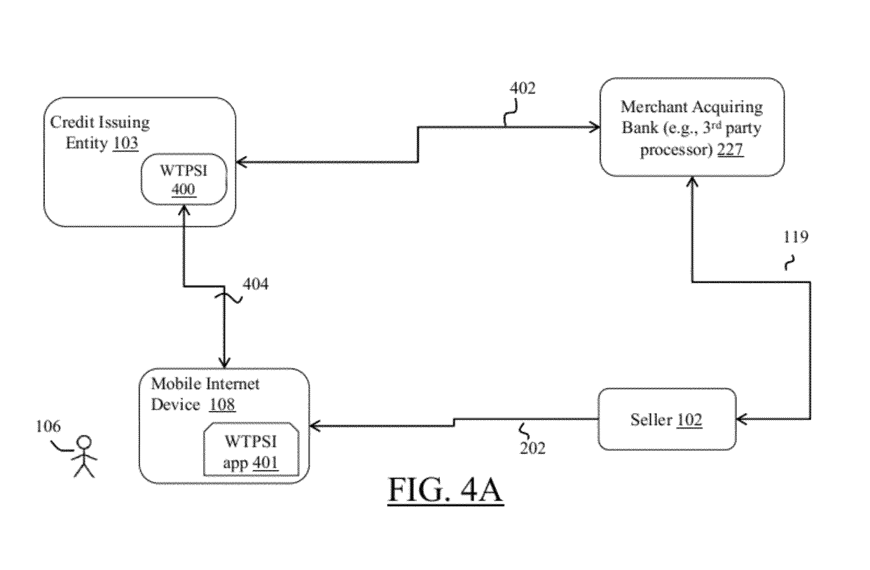

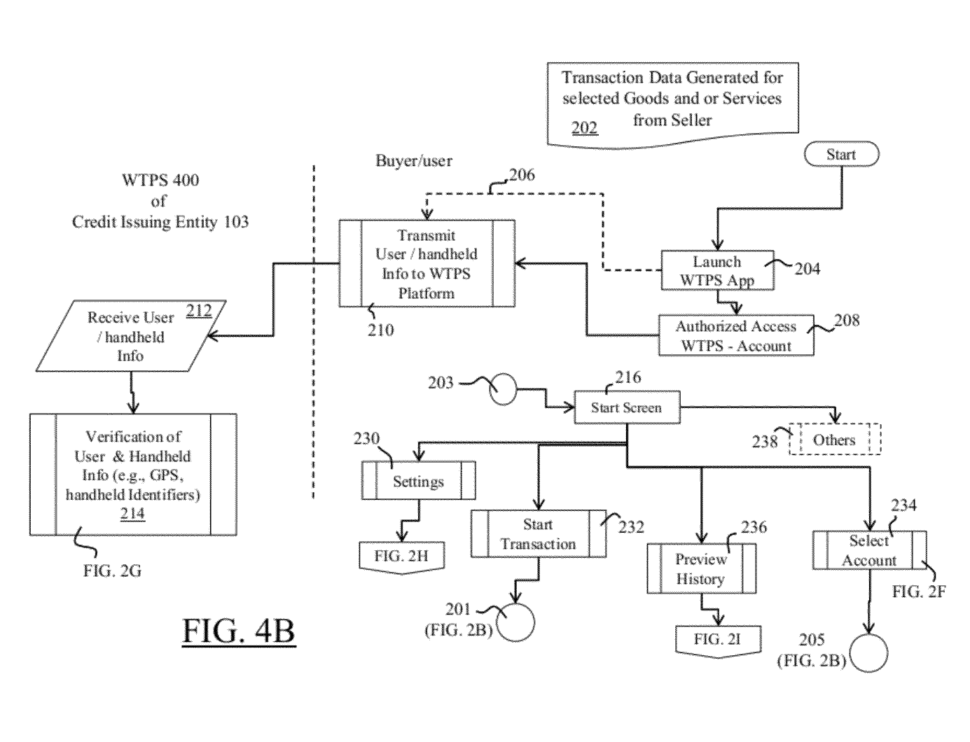

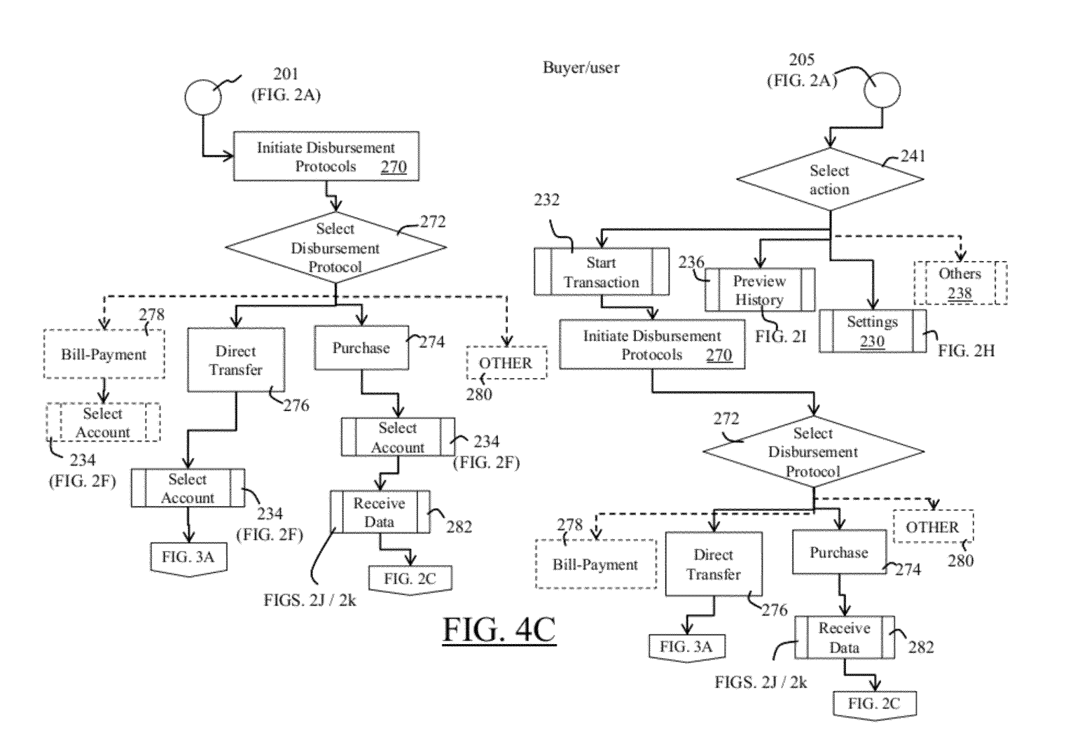

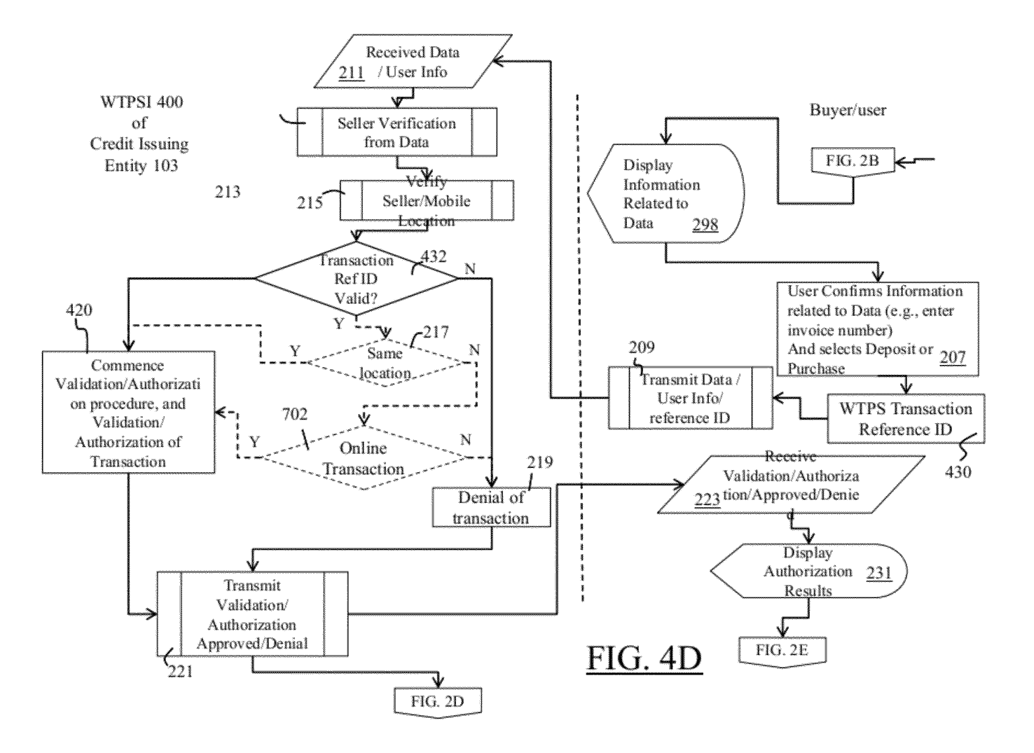

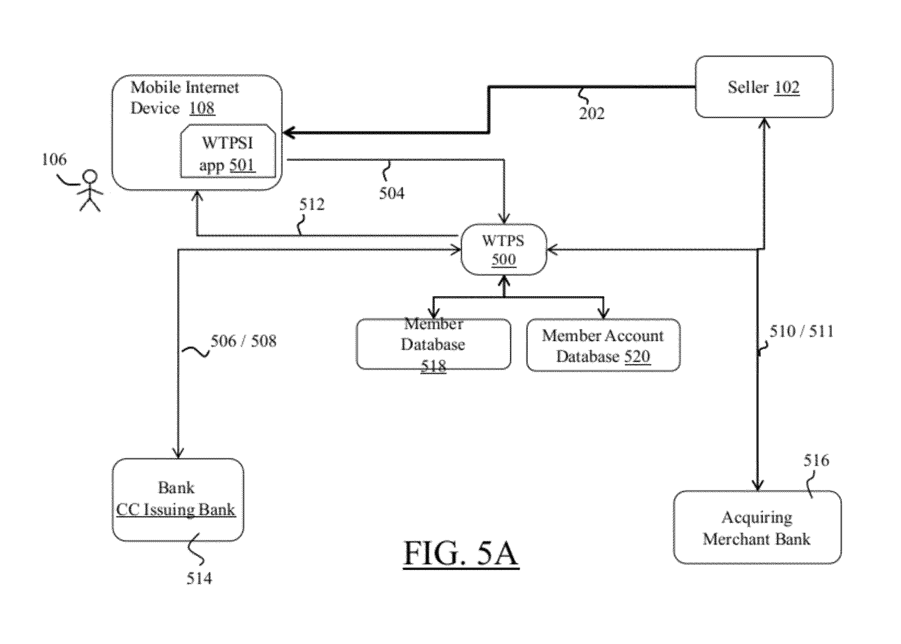

FIG. 4A is an exemplary system overview of the wireless transaction processing system of the present invention integrated within one or more financial entities (e.g., credit issuing entity 103) in accordance with the present invention. The integrated WTPS 100 with an existing credit issuing entity 103 (hereinafter referred to as WTPS 400 for greater clarity in relation to detailing the various architectures) enables for a more direct transaction processing, and reduces time for validation and authorization of transactions. The WTPS 400 can also allow credit organizations to provide their own payment network instead of relying on existing credit/debit card networks 105, which may eliminates fees associated with the existing credit/debit card networks 105.

As illustrated in FIG. 4A, the WTPS 400 is integrated within a credit issuing entity 103 such as a bank that issues credit. For each credit issuing entity 103, the buyer 106 would have to have a separately branded and associated version of WTPS mobile application 401. This is similar to buyers 106 having separately branded cards associated with each different credit issuing entity 103. Additionally, each credit issuing entity 103 includes a version of WTPS 400 that may be self-branded for their use. Accordingly, when a buyer opens an account (e.g., a savings, checking, credit/debit, line of credit, etc.) with a credit issuing entity 103, their account would have access to WTPS 400 of that credit issuing entity 103. Upon establishment of an account with the credit issuing entity 103, that account is associated with the WTPS 400 and the buyer 106 is automatically offered access to the branded WTPS mobile application 401 of the credit issuing entity 103. Following instructions provided by the credit issuing entity 103, the WTPS mobile application 401 is downloaded to the mobile Internet device 108 (such as a mobile phone) of the buyer 106, enabling access to buyer account associated with WTPS 400. Thereafter, the downloaded the WTPS app 401 may be launched via the mobile Internet device 108 to enable a user (e.g., buyer 106) access to the WTPS 400 enabled features of their credit issuing entity 103 user account to execute various transactions or functionalities. In other words, the account provided by the credit issuing entity 103 can be accessed via the WTPS mobile app 401 by buyer 106 and used as if using a “credit card,” “debit card,” or “line of credit” to purchase, place a deposit, transfer funds, etc. without using any physical cards. Further, since the established user account being used for the transaction is provided and managed directly by the credit issuing entity 103 and available via the mobile app 401 of the WTPS 400 to buyer 106, there is no need for a credit network 105. In other words, as information regarding account balance and the availability of funds is directly managed by the credit issuing entity 103 and provided via the WTPS 400 for authorization at the point of transaction, there is no need for an external credit network 105 (which functions to provide that information).

As illustrated in FIG. 4A, the buyer 106 may select the desired items from the exemplary convenience store or seller 102 for purchase (e.g., a bag of groceries), with the seller 102 generating a transaction data 202 for the buyer 106 for the selected goods and or services. The transaction data 202 includes all required information mentioned above in relation to FIGS. 1A to 3E that identifies the items purchased and pricing, and the merchant or seller 102 information, non-limiting, non-exhaustive listing of which may further include merchant name, address, phone, merchant terminal identifier or merchant transaction reference ID (e.g., credit card reader), merchant account provider and number (e.g., merchant bank name, merchant bank ID, merchant account ID, or any other non-confidential information that would enable the credit issuing entity 103 to communicate with and or transfer (or credit) funds to the merchant bank associated with seller 102, etc.). As was stated above, a non-limiting example of a third party processor 227 may be a merchant bank that functions as a merchant service provider (e.g., providing a merchant account to seller 102 for enabling the seller 102 to accept card-based types transactions). Accordingly, the transaction data 202 must include sufficient (non-confidential) information about the seller (and merchant service provider) so to enable transfer or crediting of funds for the purchase of items by the buyer 106.

When a buyer 106 makes a purchase from the seller 102 using the mobile Internet device 108, transaction data 202, including buyer 106 information (e.g., GPS location, etc. as shown and described above in relations to FIGS. 2A to 2L) is communicated via 404 to the WTPS 400 of the credit issuing entity 103. The credit issuing entity 103 receives the transaction information via 404, confirms it, and if the buyer has sufficient credit for payment of the transaction, then the credit issuing entity 103 issues an approval to the merchant acquiring bank (or third party processor 227), which, in turn, communicates via 119 the results (approval/denial) with the seller 102. After the transaction is complete, the account of the buyer 106 is debited by the purchase amount and the account of the seller 102 (e.g., seller merchant account) is credited by the same amount, and the respective accounts of the buyer 106 and seller 102 are updated in all entities involved in the transaction. The information exchange between the third party processor 227 (or merchant acquiring bank) and seller 102 (via 119) is well-known. Accordingly, with the WTPS 400, a buyer 106 uses the mobile Internet device WTPS app 401 of the WTPS 400 to access the user established bank account to commence and complete a transaction without the buyer 106 using a credit card or the credit issuing bank 103 using the credit cards network 105.

It should be noted that with this embodiment, a seller 102 need not bank with the credit issuing entity and therefore, need not have any account associated (or registered) with the WTPS 400. Additionally, the integration of WTPS 400 with the issuing entity 103 would enable the issuing entity 103 to instantaneously be cognizant of the available balance and credit amount for each user 106 without using the credit/debit card network 105 since all transactions for buyer 106 are through the buyer account associated with WTPS 400 of the credit issuing entity 103. In other words, the credit issuing entity 103 no longer needs to communicate with the credit/debit card network 105 to determine the availability of funds and total amount credited to the consumer since the account of the buyer with the credit issuing entity 103. This eliminates the dependents or the need for the credit/debit card network 105, which speeds up the transactions, and lowers overall transaction costs.

FIGS. 4B to 4D are exemplary detailed flowchart illustrations of the details of the contactless wireless transaction processing system of FIG. 4A in accordance with the present invention. The WTSP 400 details shown in FIGS. 4B to 4D includes similar corresponding or equivalent components, interconnections, and or cooperative relationships and functions as the WTPS 100 that is shown in FIGS. 1A to 3E, and described above. Therefore, for the sake of brevity, clarity, convenience, and to avoid duplication, the general description of WTPS 400, and those shown in FIGS. 4A to 4D will not repeat every corresponding or equivalent component and or interconnections or functions that has already been described above in relation to WTPS 100 detailed in FIGS. 1A to 3E.

With the WTPS 400 the seller 102 need not be a registered member of the WTPS 400 associated with the credit issuing entity 103, but must still be a member of an instance of WTPS in order to initiate the WTPS transaction therefore, only the buyer 106 is required to have an account with the specific credit issuing entity 103 that includes an integrated WTPS 400. The account setup and the registration requirements and methods and online access to features of WTPS 400 associated with the buyer account may be governed by the credit issuing entity 103 within which the WTPS 400 is integrated.

As best illustrated in FIG. 4B, the details shown and described for various entities in FIG. 2A apply to the WTPS 400 with the exception that instead of using WTPS 100 or WTPS app 190, it is the WTPS 400 integrated within the credit issuing entity 103 and the associated WTPS app 401 that is used. Accordingly, the above description with respect to FIG. 2A applies to FIG. 4B, with the reader substituting the instances of WTPS 100 with WTPS 400, and WTPS 190 with WTPS 401.

As illustrated in FIG. 4C, the details shown and described for various entities in FIG. 2B apply to FIG. 4C with the first exception that (as with FIG. 4B) the WTPS 400 and WTPS app 401 are used instead of WTPS 100 and WTPS app 190, and the additional exception that the operational functional act bill-payment 278 may be optional and may be implemented by the credit issuing bank 103, rather than be a part of WTPS 400.

As illustrated in FIG. 4D, the details shown and described for various entities in FIG. 2C apply to FIG. 4D with the following exceptions. As with FIGS. 4B and 4C, with FIG. 4D, the WTPS 400 and WTPS app 401 are used instead of WTPS 100 and WTPS app 190. Further, the operational functional act 420, which is the start of validation/authorization procedure and validation/authorization of transaction, is executed by the credit issuing entity 103 within which the WTPS 400 is integrated, rather than by WTPS 100 and or a third party 227. In particular, if the WTPS 400 of the credit issuing bank 103 optionally determines that the seller 102 and buyer 106 are in the same location (operational functional act 217) or optionally the transaction is an online purchase (operational functional act 702), then the credit issuing bank 103 may executes operational functional act 420.

The description and the illustration in FIGS. 3A to 3E for WTPS 100 and WTPS app 190 apply to the WTPS 400 and WTPS 401 with the exception that WTPS 100 and WTPS app 190 are substituted with the WTPS 400 and WTPS 401.

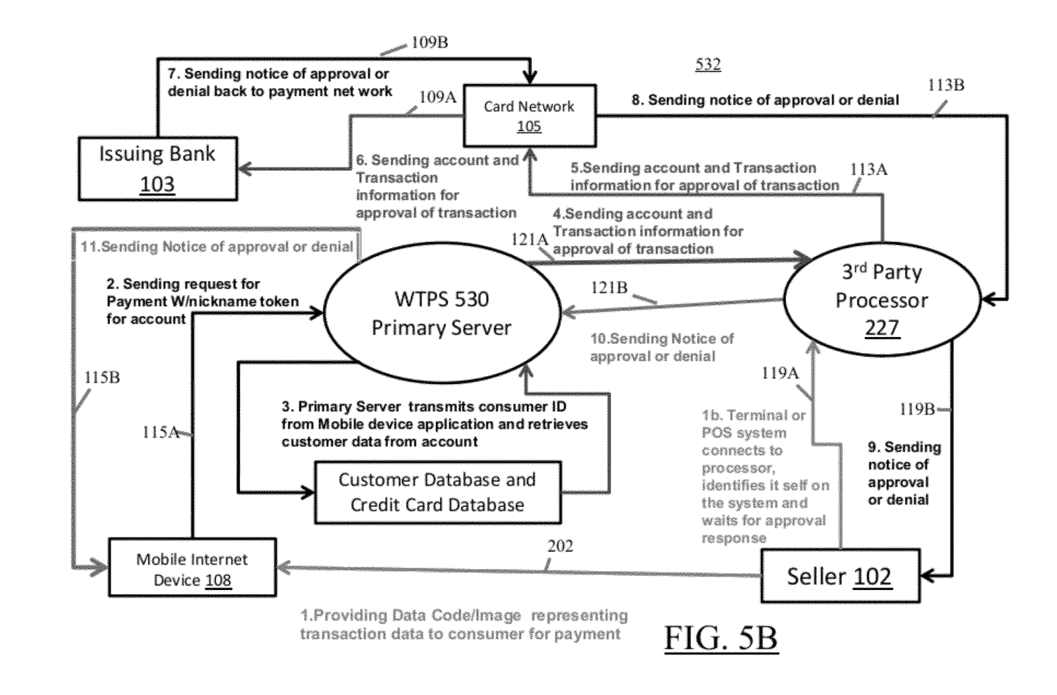

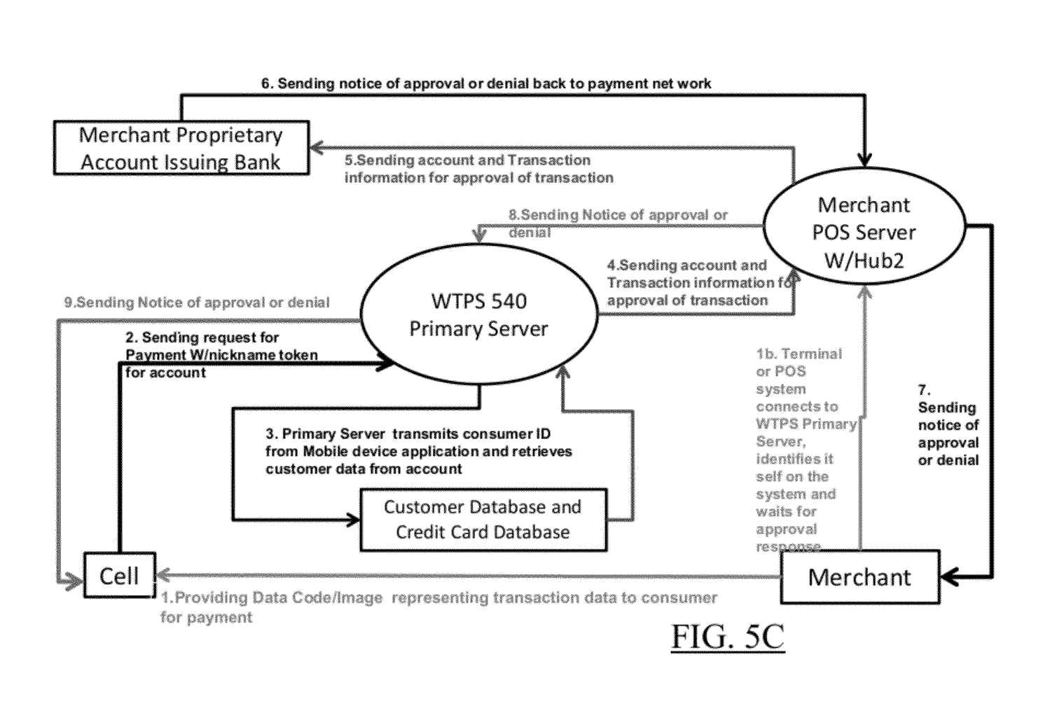

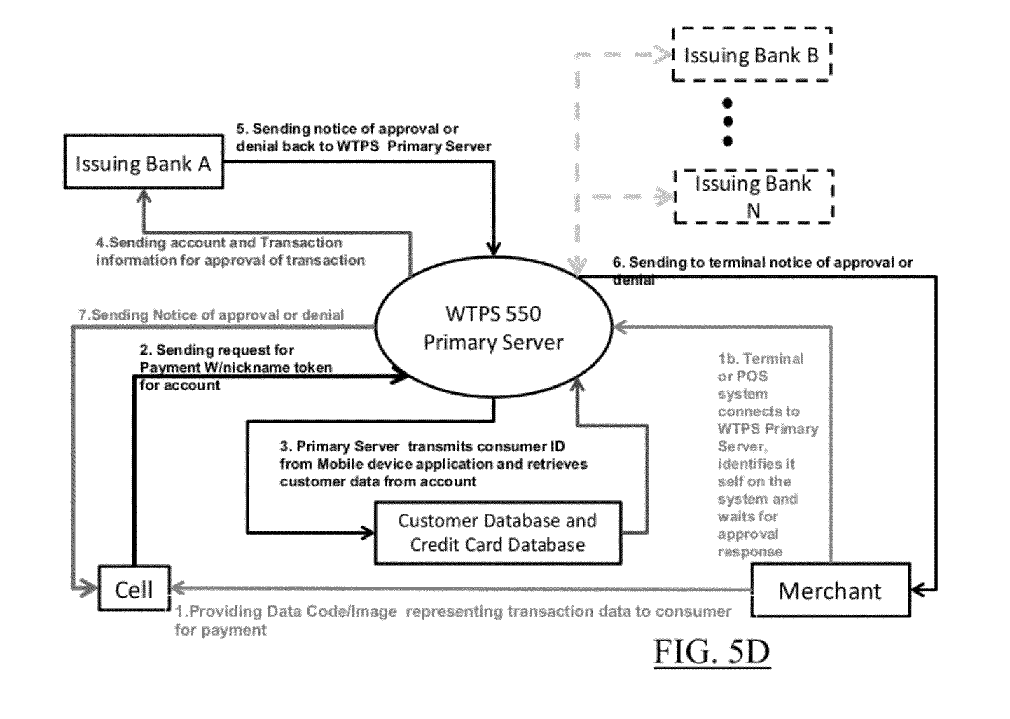

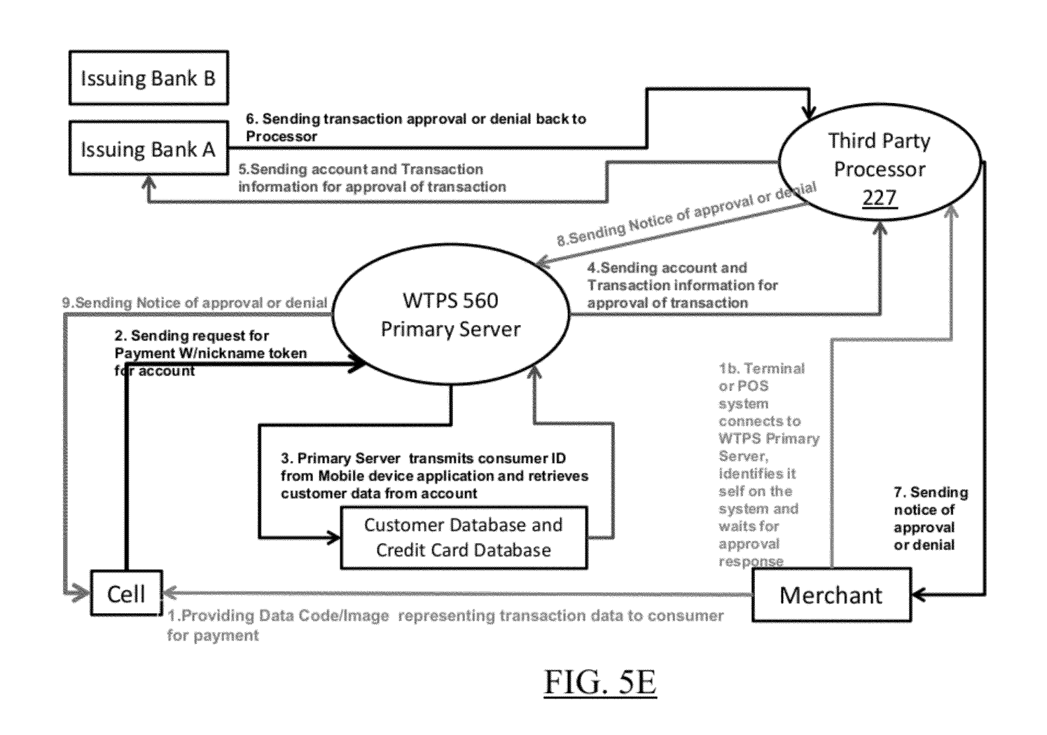

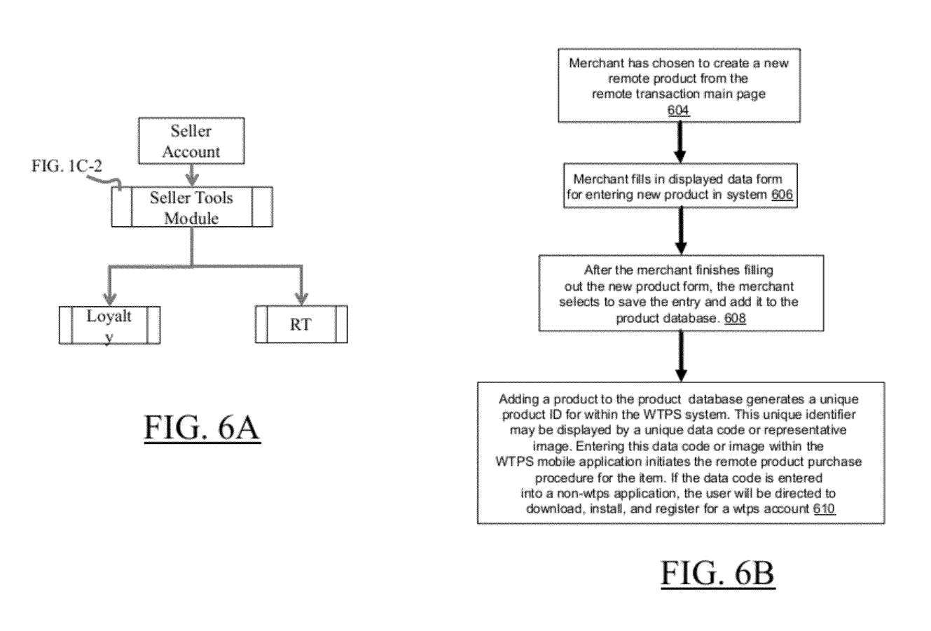

A benefit of the entire WTPS in accordance with the present invention is that WTPS provides a mechanism to track various consumer activities, which may later be used by various entities to provide targeted advertisement to consumers based on consumer activity. As has been described above in relation to FIG. 1F, the WTPS 100 is a separate entity that functions as a “hub” between consumers (registered buyers 106 and registered sellers 102), credit issuing entities 103, card networks 105, and the optional third party processors 227 for processing cashless transactions. As has further been described above in relation to FIG. 4A, WTPS 400 is fully integrated version of WTPS 100 with an existing credit issuing entity 103 and or a third party processor 227, rather than functioning as a standalone platform. FIGS. 5A to 5E are non-limiting, exemplary illustrations of additional transactional architecture systems within which the WTPS platform may be used in accordance with the present invention. The related descriptions of FIGS. 5A to 5E include similar corresponding or equivalent components, interconnections, and or cooperative relationships as the WTPS 100 of FIG. 1F and described above. Therefore, for the sake of brevity, clarity, convenience, and to avoid duplication, some of the general descriptions of FIGS. 5A to 5E may not repeat every corresponding or equivalent component and or interconnections that has already been described above in relation to WTPS 100, shown in FIG. 1F.

FIG. 5A is a non-limiting, exemplary system overview of a hybrid wireless transaction processing system that combines certain features of the independent (WTPS 100) and integrated (WTPS 400) versions of the WTPS into a hybrid wireless transaction processing system (WTPS 500) in accordance with the present invention. Accordingly, with the WTPS 500 of the present invention, the mobile Internet device 108 additionally no longer directly communicates with the credit issuing entity 103 (WTPS 400 shown in FIG. 4A), but the communication is accomplished via the WTPS primary server (similar to the WTPS 100 shown in FIG. 1F).

As with WTPS 100 and WTPS 400, the WTPS 500 includes a plurality of servers that provide a hub for communications and cashless transactions between diverse entities. As illustrated in FIG. 5A, the registered buyer 106 may select the desired items from the exemplary registered seller 102 for purchase (e.g., a bag of groceries), with the seller 102 generating a transaction data 202 for the buyer 106 for the selected goods and or services. The transaction data 202 includes all required information mentioned above in relation to FIGS. 1A to 4D. The transaction data 202 generated for the selected products is associated with a registered seller account (registered with WTPS), with the transaction data 202 having no information considered confidential.

When a buyer 106 makes a purchase from the seller 102 using the mobile Internet device 108, the received transaction data 202, including buyer 106 information (e.g., GPS location, etc. as shown and described above in relations to FIGS. 1A to 4D) is communicated via 504 of the WTPS app 501 with the WTPS 500. In other words, the buyer mobile Internet device 108 receives the transaction data 202 (once the consumer is presented the transaction data 202, the consumer may launch the WTPS app 501 on their respective mobile Internet device 108 and follow the various functionalities and operations detailed in relation to FIGS. 1A to 4D), and upon confirmation, a WTPS transaction reference ID is dynamically generated by both the mobile Internet device and the contactless wireless transaction processing system platform WTPS 500, with the WTPS transaction reference ID associated with the transaction. The buyer mobile Internet device 108 transmits via 504 (in similar manner described in relation to FIGS. 1A to 4D) the transaction data 202 with the WTPS transaction reference ID and GPS information of the buyer mobile Internet device and location to the contactless wireless transaction processing system (WTPS 500) for validation of buyer account and location, a seller account and the seller location, transaction reference ID, and transaction data to the WTPS 500. The wireless transaction processing system (WTPS 500) validates transmitted information against a WTPS registered members (registered buyer and registered seller) database 518, including against a WTPS registered accounts database 520 (registered buyer and registered seller accounts) to determine a financial entity 514 (e.g., the credit issuing bank) with which the buyer account is associated. It should be noted that the term “credit issuing bank” should not be narrowly construed as those institutions that issue credit card, but the term “credit” may be broadly interpreted as any account (even a simple checking account) that may have a line of credit or deposited (or credited) funds (real or virtual) to be debited for a transaction. The WTPS 500 confirms the financial entity 514, and transmits the buyer account and transaction information (that may optionally include the above seller information described in relations to FIGS. 1A to 4D) to the buyer financial entity 514 for authorization of the transaction. The financial entity 514 receives the buyer account and transaction information via 506 (which may also optionally include the seller banking information or the acquiring merchant bank 516), and processes the received account and transaction information, including verification of accounts and funds.

The financial entity 514 encrypts and transmits authorization via 508 with either approving or denying the transaction back to the WTPS 500 for forwarding (511) to the acquiring merchant bank 516. The acquiring merchant bank 516 is the holder of the account of the merchant (the seller account), which enables the registered seller 102 to accept credit card payments for transactions. The acquiring merchant bank 516 may take the role of a third party processor 227 in the event that the seller 102 wishes to process a non-WTPS transaction. The authorization from the financial entity 514 may include information that notifies the acquiring merchant bank 516 (via 508) that a buyer account is to be debited and the seller account (with the acquiring merchant bank 516) is to be credited and that the financial entity 514 is authorizing by approving or denying such transaction. Accordingly, in this instance where WTPS 500 is involved, the acquiring merchant bank 516 does not function as a third party processor 227 since the financial entity 514 of the buyer 106 authorizes a transaction. Thereafter, the acquiring merchant bank 516 transmits (via 510) the authorization to seller system, notifying the seller system of the authorization denial or approval of transaction. Upon completion of the transaction, the seller account is credited and the buyer account is debited in accordance with the transaction data. Finally, the WTPS 500 transmits (via 512) the authorization to for denial or approval of the transaction to the registered mobile Internet device 108 of the buyer 106.

FIG. 5B is a non-limiting, exemplary system overview of the wireless transaction processing system that utilizes certain features of the independent WTPS 100, with the express inclusion of a third party processor for communication between the WTPS platform 530, the credit card network, and the merchant. In other words, unlike the architecture illustrated in FIG. 1F where the third party processor 227 was optional, the exemplary WTPS 530 of FIG. 5B requires the use of a third party processor by the WTPS 530.

The primary transaction architecture with WTPS 530 of FIG. 5B includes similar corresponding or equivalent components, interconnections, and or cooperative relationships as the WTPS 100 of FIG. 1F and described above. Therefore, for the sake of brevity, clarity, convenience, and to avoid duplication, the general description of FIG. 5B will not repeat every corresponding or equivalent component and or interconnections that has already been described above in relation to WTPS 100, shown in FIG. 1F.

WTPS 530 of FIG. 5B follows and uses the same entities that are described in FIG. 1F in a similar processing relationship, however, FIG. 5B requires the use of an outside third party processor 227 to communicate with the credit network 105 and to forward the approval to the merchant 102. Traditionally, the outside third party processor 227 will be the actual acquiring merchant account provider for merchant 102. This relationship between the processor 227 and the merchant is established independently of the WTPS platform.

In FIG. 5B, the transaction process starts as described in FIG. 1F up to where the transaction data 202 is submitted to and verified by WTPS 100. Thereafter, the transaction data 202 is submitted (via 121A) to third party processor 227 for processing. The third party processor submits (via 113A) to the credit card network 105 to process the approval (via 109A) with credit issuing entity 103. The credit issuing entity 103 submits (via 109B) the approval/denial to credit card network 105, which in turn, forwards (via 113B) the approval/denial response to the third party processor 227. Thereafter, the approval/denial is sent (via 119B) to seller 102 to complete the transaction. Alternatively, a notice is sent (via 121B) to WTPS 530 to update customer database and to notify (via 115B) WTPS app 190 on the mobile internet device 108. It should be noted that rather than the seller 102 establishing a connection with WTPS platform at the start of the transaction, in FIG. 5B the seller 102 establishes a communication via 119A with third party processor 227 to receive approval.

FIG. 5C is a non-limiting, exemplary system overview of a closed loop environment embodiment of the wireless transaction processing system in accordance with the present invention. The closed loop environment of the present invention shown in FIG. 5C uses certain features of the independent WTPS 530, but with the express exclusion of a third party processor and credit card network. In other words, unlike the architecture illustrated in FIG. 5B where the third party processor 227 and network 105 was used for approval, the exemplary WTPS 540 of FIG. 5C communicates and receives approval directly from a merchant proprietary account issuing bank.

The transaction architecture with WTPS 540 of FIG. 5C includes similar corresponding or equivalent components, interconnections, and or cooperative relationships as the WTPS 530 of FIG. 5B and described above. Therefore, for the sake of brevity, clarity, convenience, and to avoid duplication, the general description of FIG. 5C will not repeat every corresponding or equivalent component and or interconnections that has already been described above in relation to WTPS 530, shown in FIG. 5B.

In a closed loop architecture environment (as illustrated in FIG. 5C) the merchant 102 does not have a third-party merchant processor 227 or connection to a credit card approval network 105. Instead the merchant 106 is directly connected to either an independent credit account issuing bank (or a proprietary credit account issuer) 103 for that merchant 102 via a Point-Of-Sale (POS) system server. In FIG. 5C, the purchase process originates the same as it does for FIG. 5B up to WTPS 540 receiving and validating the transaction data. Thereafter, the WTPS 540 forwards the validated transactional data to the merchant POS server for approval processing through the merchant proprietary account issuing bank 103. Once the merchant proprietary account issuing bank 103 has determined either an approval or denial for the transaction, the results are forwarded back to the merchant POS server to complete the transaction. At this point completion notices are forwarded both to the merchant 102 for completion and the WTPS 540, which passes the notice to the WTPS app 190 of the consumer mobile device 108. It should be noted alternately, the WTPS 540 may communicate validated transaction data directly with the merchant proprietary account issuing bank 103. In such an instance, a merchant originated transactional reference ID is transmitted with the transmitted data 202 and forwarded with other transactional data to the merchant proprietary account issuing bank 103 from WTPS 540. The merchant originated transactional reference ID is used to facilitate direct communication for approval or denial between merchant proprietary account issuing bank and the merchant POS server. Once the merchant POS server directly receives approval/denial of the transaction, the POS server forwards a message to WTPS 540 for notifying the consumer 102 (via WTPS app 190 on the mobile Internet device 108).

FIG. 5D is a non-limiting, exemplary system overview of an embodiment of a direct approval environment of the wireless transaction processing system in accordance with the present invention. The direct approval transaction diagram of the present invention shown in FIG. 5D uses certain features of the independent WTPS 530 (of FIG. 5B), but with the express exclusion of a third party processor and credit card network. In other words, unlike the architecture illustrated in FIG. 5B where the third party processor 227 and network 105 was used for approval, the exemplary WTPS 550 of FIG. 5D communicates and receives approval directly from a consumer credit account issuing bank 103.

The transaction architecture with WTPS 550 of FIG. 5D includes similar corresponding or equivalent components, interconnections, and or cooperative relationships as the previously disclosed transactional architectures of WTPS 530/540 of respective FIGS. 5B/5C and described above. Therefore, for the sake of brevity, clarity, convenience, and to avoid duplication, the general description of FIG. 5D will not repeat every corresponding or equivalent component and or interconnections that has already been described above in relation to WTPS 530/540, shown in FIGS. 5B and 5C.

In this embodiment of direct approval system transactions occur between four distinct entities. This four point direct approval system architecture is similar to a closed loop environment however the WTPS 550 takes the place of a merchant POS server, and a merchant proprietary credit account may not exist. WTPS 550 interacts with multiple third party issuing banks to provide direct approval for the bank's own proprietary credit accounts. These proprietary credit accounts are similar in essence to current conventional credit card accounts however they do not rely upon the outside credit card networks or third-party processors to process and generate approvals. Approvals are achieved by direct data connection to the issuing banks for those credit accounts and the WTPS 550 notifies the merchant directly of the approval or denial using the direct and previously established connection made by the merchant's POS or credit card authorization terminal at the start of the transaction process.

FIG. 5E is a non-limiting, exemplary system overview of another embodiment of a direct approval environment of the wireless transaction processing system in accordance with the present invention. The direct approval transaction diagram of the present invention shown in FIG. 5E uses certain features of the independent WTPS 530 (of FIG. 5B), but with the express exclusion of credit card network. In other words, unlike the architecture illustrated in FIG. 5B where the third party processor 227 and network 105 was used for approval, the exemplary third party processor 227 of FIG. 5E communicates and receives approval directly from a consumer credit account issuing bank 103.

The transaction architecture with WTPS 560 of FIG. 5E includes similar corresponding or equivalent components, interconnections, and or cooperative relationships as the previously disclosed transactional architectures of WTPS 530 of FIG. 5B and described above. Therefore, for the sake of brevity, clarity, convenience, and to avoid duplication, the general description of FIG. 5E will not repeat every corresponding or equivalent component and or interconnections that has already been described above in relation to WTPS 530, shown in FIG. 5B.

In this embodiment of direct approval system transactions occur between five distinct entities. This five point direct approval system architecture is similar as in FIG. 5B, above. However, the third party processor 227 does not connect to a credit card network 105 for transaction authorizations. Instead, the third party processor 227 will directly connect to the issuing bank 103 for the chosen credit account to seek approval for the transaction. Once the transaction is approved or denied, issuing bank 103 forwards a signal back to the third party processor 227 which will in turn forward notices to both WTPS 560 and the seller 102 using established and traditional data transmissions between a processor and their merchant's authorization equipment or systems. As a final step, the WTPS 560 will notify the WTPS app 190 on the consumer mobile device 108 that the transaction has been either approved or denied, and will record the transaction in the customer database.

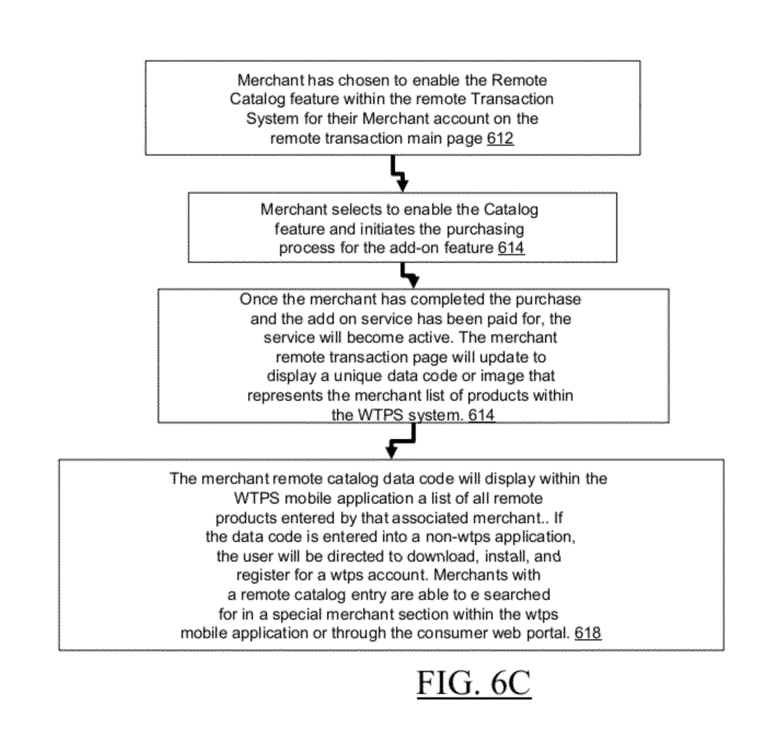

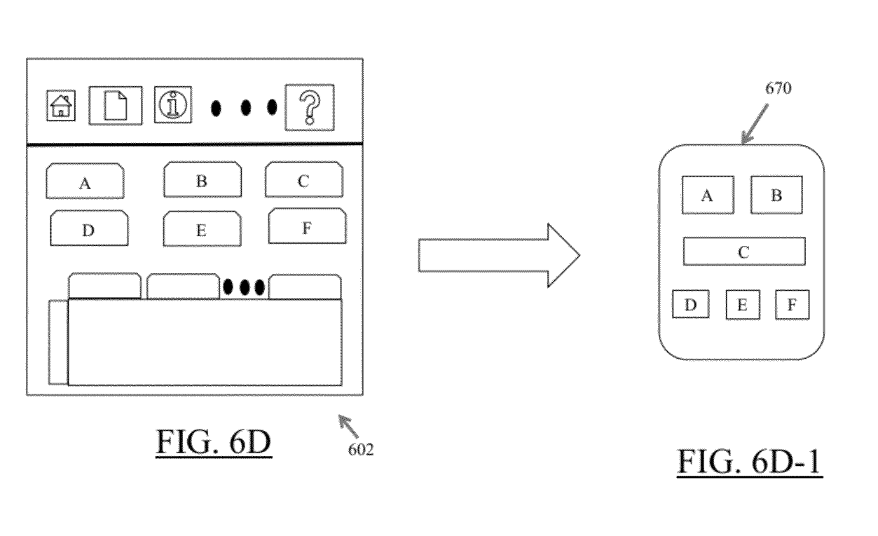

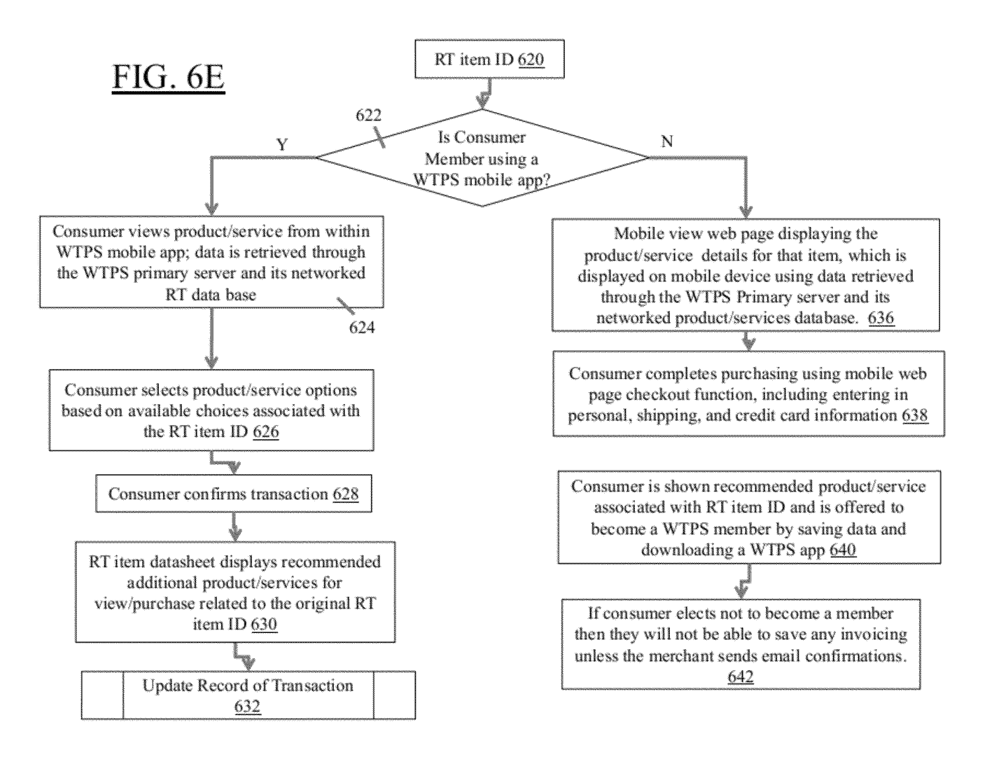

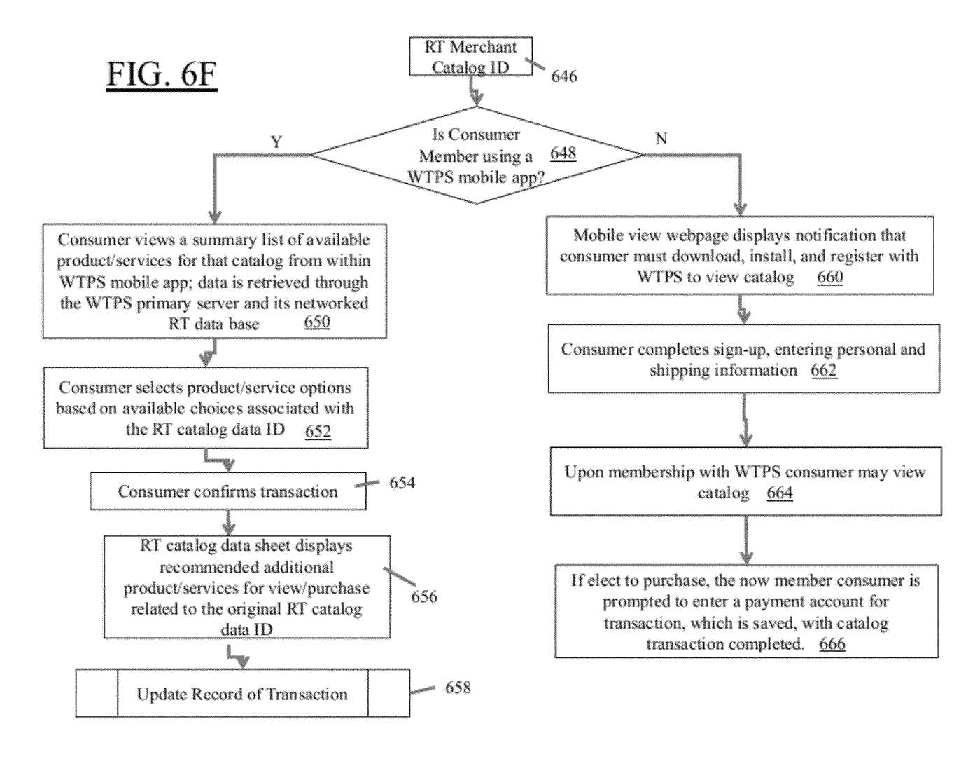

FIGS. 6A to 6F are non-limiting, exemplary illustrations of a Remote Transaction system (RTS), optionally presented as a remote transaction module (RTM) of the WTPS in accordance with the present invention. Remote Transaction (RT) is a feature (which may be implemented as a standalone system (RTS) or as a module (RTM) of WTPS) that offers transaction capabilities in remote environments where transactions can be made more productively. With RT, no physical storefront or online e-commerce website is needed for a merchant to conduct transactions. The RT handles transactional processing, with only a transactional data (representative of product or services) required to be displayed in order to commence a transaction. That is, no direct presence of a seller is needed for the transaction, and thereafter, the transaction is handled in similar manner described above with respect WTPS.

Registered sellers that are a member (or subscriber) of RT may upload and save item data related to their products (or items) into an RT database, with the RT providing sellers with unique, individual identification associated with each item (i.e., product or service) and or the seller. A listed “item” is an “entry” made as a data that may be an entry for a product or a service and hence, the term “item” should not be construed as an article or product. The identification (RT item ID and or RT seller ID, detailed below) may be in a machine-readable representation (e.g., a QR code) that may be transmitted or displayed by the seller on a variety of media for retrieval by a buyer (for example, buyer using any of the WTPS apps mentioned above on a mobile Internet device).

As a very specific non-limiting example for better understanding of the RT, a seller with different types of artwork for example, may register with RT and upload item data related to each artwork. That is, for each individual artwork, the seller uploads all relevant information for that particular artwork onto the RT servers. Non-limiting, non-exhaustive listing of item data for each individual artwork may include, for example, price, the artist information related to that artwork (e.g., historical data related to the artist), availability (in terms of quantity, date, etc.), seller information such as shipping, discounts, recommendations, etc. Once all data is uploaded for each item (e.g., product or service), upon saving the uploaded information, the seller receives a unique item ID (RT item ID) associated with each individually uploaded and saved data.

It should be noted that once one or more items are entered, the seller is provided with an option to add recommended items. The recommended items (products) may simply be just an entry that is selected to be associated with another entry. For example, a seller may have three artworks, with the third entry associated with the second entry as a further recommendation. The recommendation option is a part of item data that is entered and saved. In other words, upon entry of a third item, the data for that item may point to the second item and when buyer views the second item, they will see the third item as a recommendation. It should be noted that a seller may choose to optionally recommend products from another seller account.

The item ID representation may be in a form of a QR code or any other code such as a bar code or image representation (of item ID) that may be easily displayed within any media such as video, a news paper classified/wanted ads sections or an art magazine. Any individual with a device that is capable of reading the RT item ID (e.g., within a QR code) may simply scan the code to retrieve an item data from the RT database that includes all data related to the item (which in the case of the above example, would be a particular artwork). The displayed RT item data on the user device also provides the capability for the purchase of the product associated with the RT item data. With RT, there is no requirement for a seller to have a storefront or website to sell listed items and more importantly, all that a seller is required to do is to advertise the item ID (e.g., within a QR code) on any media to advertise the sale of a listed item (i.e., a product or a service). The item ID may be placed on any type of media—from simple flyers to pass onto the neighbors to exclusive and pricey art magazines or any website. Further, since the item ID (e.g., illustrated within a QR code) does not take too much space, the cost of the print ad to the seller of the listed item is substantially reduced. This is especially true if the seller places the QR code within a flyer of another business that sends out flyers.

The RT may also be used to catalog data item (i.e., products), which facilitates the searching for that item by WTPS consumers. The RT catalog feature (if enabled as a result of subscription by a seller) allows sellers to advertise a single RT seller ID (e.g., a RT seller QR code) that would provide users access to all listed items of that seller with RT database. Therefore, instead of advertising multiple individual RT item IDs (e.g., multiple RT item QR codes) for each item entry (product or service), the seller merely advertises a single RT seller ID, allowing access to all RT item entries related to the seller. It should be noted that a seller may have a single entry in the RT database and still enable the catalog feature (by subscription or payment). The benefit of enabling the catalog feature for sellers (even if they only have a single entry (product) is that the catalog feature provides the buyers with enhanced searching capabilities to find desired products of a seller.

An example of a catalog feature (with multiple listed items) is a restaurant menu, wherein each item on the menu will have its own individual item ID (as described above), but the entire menu for that restaurant may be classified as a catalog, providing the restaurant a RT seller QR code. Upon scanning the restaurant RT seller QR code, buyers will have access to the menu and individual menu items from which to select, with each individual menu item having its individual RT item ID. It should be noted that in RT catalog environment the individual QR codes for each RT item is not displayed (as a result of receiving the RT seller QR code). Individual item data is listed in summary format where the user has the option of viewing the individual complete details of each item, where multiple items selected and combined into a single transaction. With RT, the seller does not need or require a restaurant, a storefront, or website to sell a food and more importantly, all that an RT seller is required to do is to advertise the RT seller ID (e.g., within a QR code) on any media to advertise the sale of a plurality of items within the RT database. It should be noted that buyers (whether or not registered with RT/WTPS) are never taken outside the WTPS when the RT seller ID and or RT item ID are received by their mobile Internet device, but the RT item data or RT catalog data is retrieved from the RT database.

As illustrated in FIG. 6A, a seller may access the RT 600 via a seller tools section of the WTPS (shown in FIG. 1C-2). The present invention may optionally provide the RT 600 as a fee based system (e.g., subscription or one time fee payment) wherein a registered seller (with RT as a standalone system or with WTPS for the RTM) may pay a fee for accessing the RT services. Subscription to the RT provides the seller with access to the RT service, which among others includes an RT item datasheet 602 (FIG. 6D), enabling the seller to manually input or automatically upload item data related to an entry (i.e., product).

As illustrated in FIG. 6B, once a merchant has selected the RT tools from the seller tools module (FIG. 6A), the merchant is presented with the summary overview (e.g. a dashboard) of the RT system wherein the Merchant may select to create a new RT product 604 (FIG. 6B) from the RT main page. Thereafter, the merchant completes (at operational functional act 606) in displayed data form (RT item datasheet 602) for entering new product in RT. At the next operational functional act 608, after the merchant completes data entry, the merchant may select to save the entry and add the entered data (via the RT item datasheet 602) to the product database. As further illustrated in FIG. 6B, at the operational functional act 610, adding a product to the product database generates a unique product ID (RT item ID) for within the WTPS system. The above operational functional acts of 604 to 610 may be repeated for each added item. At the buyer end, the unique identifier (RT item ID) may be displayed by a unique data code or representative image (e.g., a QR code), whereby entering this data code or image within the WTPS mobile application of the buyer initiates the RT transaction procedure for the item, displaying the RT item data in WTPS application using a non-limiting exemplar template 670 (shown in FIG. 6D-1). If the data code is entered into a non-WTPS application, the user may be directed to a mobile webpage displaying the item data or, may be directed to download, install, and register for a WTPS account.

The RT item datasheet 602 (FIG. 6D) may include a variety of well known tools such as pull down menus for selection of a variety of options for example, product or service category, availability of the product or sale with respect to certain times or dates, and so on. As indicated above in relation to FIG. 6B, the seller enters data related to a product or service into the RT database by completing the RT item datasheet or by uploading a spreadsheet data formatted to cooperate with the RT database. The actual product related data (or RT item data) provided may include, but is not limited to media uploads (video, photo, sound, text, etc.), name of product or service, description of product or service, item or service category, price, optional choices for product (size, color, etc.) or services (certain sales, business hours, etc.), shipping options, product images or service logo, recommended additional products or services for sale associated with the product or service, very similar to an e-commerce store. Accordingly, the RT item datasheet 602 may be thought of as a RT input GUI for end users (registered seller 102) with various control tools (pull down menus, selection buttons, upload options, textbox, etc.) that enables the user to input information (RT item data) related to a specific product or service into the RT database.

As further indicated above in relation to FIG. 6B, once the RT item datasheet 602 with RT item data is saved within the RT database, the RT provides the end user (the seller 102) with an RT item ID, which is associated with the specific RT item datasheet containing the RT item data associated with a particular product or service. The RT item ID may be referenced by or represented and presented to users (e.g., buyers 106) in numerous ways, a non-limiting, non-exhaustive listing of example of which may include a bar code or a QR code that reference the RT item ID. Therefore, the RT item ID may be thought of as an RT transaction data that may be used by a potential buyer (e.g., scanning a QR code by a mobile Internet device) to view and if desired, purchase a product. That is, receiving and processing the RT transaction data by the WTPS buyer or RT buyer will retrieve the RT item data associated with the RT item ID from the RT database. The RT item ID (e.g., a QR code representation thereof) may be used and placed in most locations (e.g., movies, magazines, websites, videos, etc.). Non-limiting examples of which may include a variety of media of advertisements, enabling access to the product or service by the mobile Internet device that receives the RT transaction data (or RT item ID). This enables the mobile Internet device to display RT item data from the RT item datasheet associated with the product or service retrieved from one or more servers for view, displayed using RT item display template 670 (FIG. 6D-1), and if desired, purchase the product or service using the options available. It should be noted that the RT item ID may be actually printed adjacent to a QR code representation of the RT item ID. The actual RT item ID is provided in case the user cannot or has no means of receiving (e.g., scanning) representation of the RT item ID. For example, a user may not be able to receive or scan the RT item ID (e.g., within a QR code) on their mobile Internet device at which point, the user may simply enter in the RT item ID manually into any of the abovementioned WTPS apps.

As stated above, in the remote transaction system or module as part of the WTPS, merchants (once logged into the merchant portal and having accessed the merchant tools area) are able to enter in products to be available within the RT/WTPS system for immediate and direct purchase. Each item has its own entry and identifying data code, which may be used by buyers to conduct immediate transactions without the seller needing an online or physical store or the buyer visiting the online or physical store.

FIG. 6C is a non-limiting exemplary flowchart for using the RT catalog module in accordance with the present invention. As illustrated, at the operational functional act 612, the merchant elects to enable the RT Catalog feature within the RT for their merchant account on the remote transaction main page. At the next operational functional act 614, the merchant selects to enable the RT Catalog feature and initiates the purchasing process for the add-on feature. At the next operational functional act 616, the RT catalog service is enabled after the merchant completes the purchase. Thereafter, the merchant remote transaction page is updated to display a unique data code or image that represents a list of that merchant's products within the WTPS system. At the operational functional act 618, the merchant remote catalog data code will display within the WTPS mobile application a list of all remote products entered by that associated merchant. If the data code is entered into a non-WTPS application, the user will be directed to download, install, and register for a WTPS account. Merchants with a remote catalog entry may be searched for in an optionally available special merchant section of the buyer tools within the WTPS mobile application or through the consumer web portal.

As detailed in relation to FIG. 6C above, in the case of the Remote Catalog Module (as mentioned above), it is an extension of the remote transaction (system or module). By electing to add a remote catalog to a merchant RT/WTPS account, merchants can choose to enable or disable products to be associated with that catalog. The catalog itself will have its own remote data code that can be presented to consumers. When entered into the WTPS mobile device application or any other mobile application that is capable of receiving and reading a catalog data code, the remote catalog code will cause to be displayed on the mobile device, in summary form, all remote products that have been enabled for that catalog. Consumers can then review the details of each item (via the RT item template 670, if using the WTPS application) and conduct a transaction of any item that they are interested in the same as they did for the individual items as described above. Within the WTPS mobile device application search functions are available as filters to display only merchants that have enabled a remote catalog sorted by various criteria.

Therefore, after the merchant subscribes to the RT catalog feature of WTPS, the merchant may enter in one or multiple items into the merchant product/service database, one item at a time as described above or by uploading a spreadsheet data formatted to cooperate with the online merchant database. The individual item data provided includes but is not limited to product (or service) id, name of product, description of product, price, optional choices for product (size, color, etc), item category, shipping options, product image, recommended additional sale items associated with product. Each product has an RT item ID available for individual use, which may or may not be disabled, depending on the merchant's individual settings.

The merchant generates a RT seller ID to identify themselves and their product catalog within the WTPS Merchant Product/Services Database (if enabled). The merchant may either save the RPMQRC as an image file for later media use or print directly from the merchant tools section of the WTPS website.

When a consumer scans the RT seller ID using the WTPS Mobile Application, the application loads with the merchant's product catalog displaying summarized product data for each item originally entered. This data may include but is not limited to image, item category, product name, short description, price, etc. At this stage, the consumer makes their selection choice and is able to review more details about a selected item (via the RT item template 670) and, if desired, complete a transaction for either that chosen item or add multiple selections together for a larger transaction encompassing multiple product choices from the merchant product catalog. During the initial transaction process, as individual items are committed to the transaction, the application displays referenced recommended items that were originally entered into the product database for that product for each item as they are chosen.

When a consumer scans the RT merchant catalog ID without using the WTPS application, the mobile browser opens to a secure mobile WTPS web page with the merchant's catalog information displayed, informing the consumer that they must download and install the WTPS application in order to view the remote catalog for that merchant. An abbreviated initial registration is conducted through the mobile web page, requesting information including but not limited to full name, address, phone number, e-mail address, desired user name and password, security access code (pin code). Upon installation, and attempted purchase from the merchant catalog, the consumer will be prompted to enter in a credit card number for the transaction through a mobile web environment. Non-limiting examples of a mobile web environment may include, a mobile browser window, an inline “web view” portal within the WTPS application, and others.

Once the initial transaction is completed, if the consumer was not originally a member of WTPS, they are offered a tutorial link where they can receive an automated tour of WTPS highlighting the key features, settings, and benefits. If they elect not to view it, they are instructed they can look any time at the help menu to view later.

FIG. 6E is a non-limiting, exemplary flowchart, which illustrates general operations of transactions with RT from a consumer (buyer) view in accordance with a non-limiting embodiment of the present invention. As illustrated, when a mobile Internet device of a consumer receives the RT item ID (similar to the manner that transaction data 202 is received), the mobile app that is able to read the RT item ID loads the RT item datasheet with the RT item data of the product or service, and displays the available information in a designed GUI format on the mobile Internet device for consumer to view product or service details.

Regardless of whether the consumer is a member of RT/WTPS, any mobile app capable of reading the RT item ID may retrieve the individual RT datasheet and display on a mobile Internet device, enabling the consumer to view and select various options in relation to the product or service being viewed. That is, the consumer views details of the product or service associated with the received RT item ID.

As illustrated in FIG. 6E, at the operational functional act 622, if the consumer does use the WTPS application to scan an RT item ID code, the WTPS app of the mobile Internet device 108 enables (at the operational functional act 624) the consumer to view product/service from within WTPS mobile app, with the RT data retrieved through the WTPS primary server and its networked RT data base. At the operational functional act 626, the consumer may select the product/service option based on available choices associated with the RT item ID for purchase, and at operational functional act 628, the consumer confirms the transaction (e.g., purchase). At operational functional act 630, the RT item datasheet displays recommended additional products/services for view/purchase related to the original RT item ID, and at operational functional act 632, the WTPS updates records of the transaction.

As further illustrated in FIG. 6E, if (at the operational functional act 622) the consumer does not use the WTPS application to scan an RT item ID code, the consumer is directed (at the operational functional act 636) to a mobile webpage to allow purchasing and sign-up with the WTPS. The mobile view web page (at the operational functional act 636) displays the product/service details for that item, which is displayed on mobile device using RT item data retrieved through the WTPS Primary server and its networked product/services database. At the operational functional act 638, the consumer completes purchasing using mobile web page checkout function, including entering in personal, shipping, and credit card information. At the next, operational functional act 640, the consumer is shown recommended product/service associated with RT item ID and is offered to become a WTPS member by saving data, choosing a username and password, and downloading a WTPS app. At operational functional act 642, if consumer elects not to become a member then they will not be able to save any invoicing unless the merchant sends email confirmations.

As stated above in relation to FIG. 6E, if the consumer does not use the WTPS application to scan an RT item ID code, the consumer is directed to a mobile webpage to allow purchasing and sign-up with the WTPS. Member consumer views product/services from within WTPS mobile app, with the data retrieved through the WTPS primary server and its networked RT database. At this stage, the consumer makes their selection choices and is able to conduct a transaction for the selected product/service. That is, consumer selects product/service options based on available choices associated with the RT item ID and confirms transaction. Thereafter (or even prior to an actual purchase and during selection process), the RT will display referenced recommended products/services associated with the original RT item ID for that product/service. In other words, RT item datasheet display recommends additional product/services for view/purchase related to the original RT item ID. Finally, a record of the transaction is updated in the consumer and merchant account logs for later available review. The record of transaction for the merchant may include, but without limitations, details of the transaction, the number of items ordered, total fees generated, etc., very similar to normal business accounting functions. The consumer record of transaction may include (without limitation) transactions details similar to transaction receipt or invoice. It should be noted that all purchasing, and most operational functional acts executed by the buyer is the same as the operational functional acts detailed in FIGS. 1A to 5E. This includes launching the WTPS app, receiving the RT item ID, selecting to purchase, and so on. It should further be noted that the use of remote transaction is the only instance where consumer information is shared with WTPS merchant. Since RT is a remote transaction where the user remotely orders a product or service, the shipping and contact information of the user is required so that the product or service of the merchant is actually delivered or shipped to the correct end user. The information provided by the consumer may include, but is not limited to the consumer name, consumer ID, account information (credit card number), etc, including all information that is used for conventional online (or “telephone/mail order”) transaction, including optionally, a merchant originated transaction reference ID.

As further illustrated in FIG. 6E, when a consumer RT item ID without using the WTPS mobile app (e.g., the consumer is not a registered member), the mobile browser opens to a secure mobile web page with the product information and options displayed. That is, a secure mobile view web page displays product/service details on the mobile device using data (RT item datasheet) retrieved through the WTPS Primary server and its networked product/services database. Thereafter, the consumer makes their selection, enters in their personal, shipping, and credit card account information for payment. In other words, the consumer completes purchasing using the secure mobile web page checkout function, including entering in personal, shipping, and credit card information. Thereafter (or even prior to an actual purchase and during selection process), the RT may display referenced recommended products/services associated with the original RT item ID for that product/service. In other words, RT item datasheet display recommends additional product/services for view/purchase related to the original RT item ID. Once the payment has been authorized, an option displays to save the information for later use by establishing a WTPS account. Choosing the option to become a member of WTPS will redirect the consumer to a download page, request that consumer to enter in a user name and password for their new account, and then allow them to download the WTPS app. By entering in the user name and password, an account is created in the WTPS customer database using the information that was provided during the transaction and using the user name and password for initial access. Upon first login, the consumer is prompted to enter in their unique confidential access code (pin code) for later logins. On the other hand, as illustrated in FIG. 6E, if consumer elects not to become a member then they will not be able to save any invoicing unless the merchant sends email confirmations. It should be noted that the invitation for membership may be extended to non-members that receive of any WTPS generated ID (and not just via remote purchasing). For example, a non-member buyer may scan a QR code of a member seller (outside of the RT). In such an instance, the non-member buyer mobile Internet device will receive an invitation to become a member as described above.

FIG. 6F is a non-limiting, exemplary flowchart, which illustrates general operations of transactions with RT catalog feature from a consumer (buyer) viewed in accordance with a non-limiting embodiment of the present invention. As illustrated, when a mobile Internet device of a consumer receives the RT merchant catalog ID (similar to the manner that transaction data 202 is received), the WTPS mobile app that is able to read the RT merchant catalog ID loads the RT catalog with the RT catalog data of list of products or services, and displays the available information in a designed GUI format on the mobile Internet device for consumer to view list of products or services details.

As illustrated in FIG. 6F, at the operational functional act 648, if the consumer does use the WTPS application to receive an RT merchant catalog ID code 646, the WTPS app of the mobile Internet device directs consumer to operational functional act 650 where the consumer views a summary list of available product/services for that catalog from within WTPS mobile app, with RT catalog data retrieved through the WTPS primary server and its networked RT database. At operational functional act 652, the consumer may select multiple products/services and options based on available choices associated with the RT catalog data ID, purchases and confirms the transaction at the operational functional act 654. The RT catalog data sheet displays recommended additional product/services for view/purchase related to the original RT catalog data ID at the next operational functional act 656, where WTPS updates records of Transaction at the operational functional act 658.

As illustrated in FIG. 6F, at the operational functional act 648, if the consumer does not use the WTPS application to receive an RT merchant catalog ID code 646, the WTPS app of the mobile Internet device directs consumer to a mobile view webpage at the operational functional act 660, and displays notification that consumer must download, install, and register with WTPS to view catalog. At the operational functional act 662, consumer completes sign-up, entering personal and shipping information, and upon membership with WTPS, consumer may view the catalog (operational functional act 664). If elect to purchase, the now member consumer is prompted to enter a payment account for transaction, which is saved, with catalog transaction completed (operational functional act 666).

It should be noted that it may be optionally available for a buyer using the WTPS application to cancel or return/refund an undelivered and incomplete transaction. To clarify, in the time period between when an RT transaction has been ordered and the final shipment has been received, it may be possible for a buyer to stop the order, pending seller approval, terms and conditions of the transaction. In this process, the buyer 106 will retrieve the translation detail from the account history section of WTPS app, upon viewing the details page for the particular transaction, the buyer 106 is presented with the option (if available), to select to cancel, refund, or return an order. This option will be presented within the GUI of the transaction details page. Once buyer 106 has elected to terminate (e.g., cancel, refund, etc.) transaction, the seller 102 is notified that the buyer wishes to terminate the transaction.

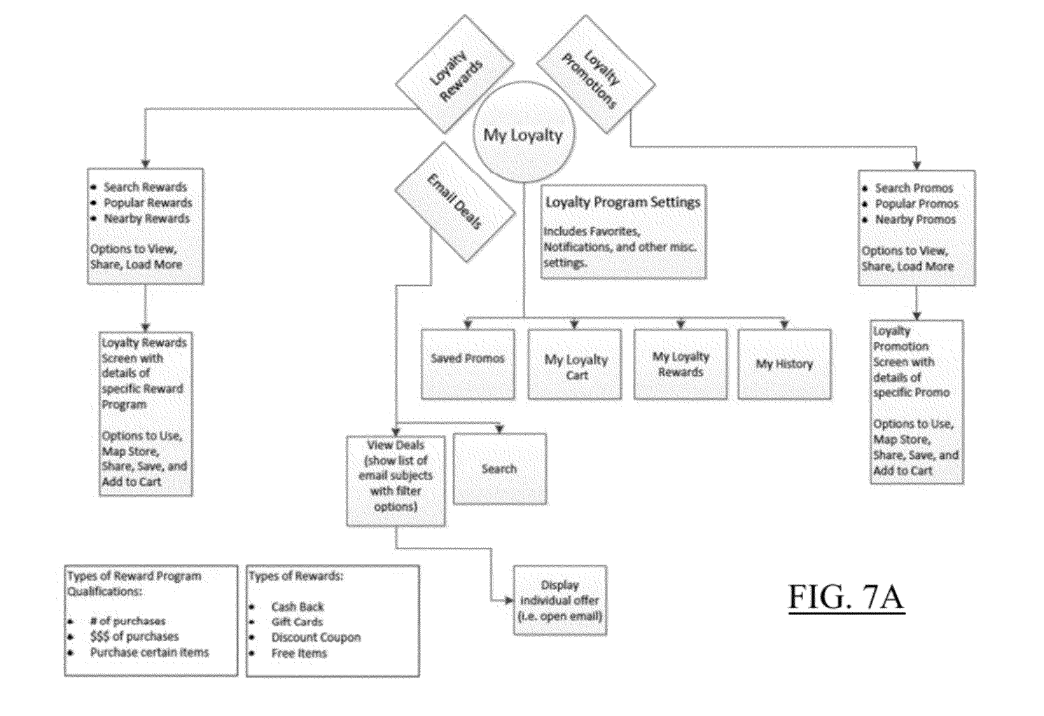

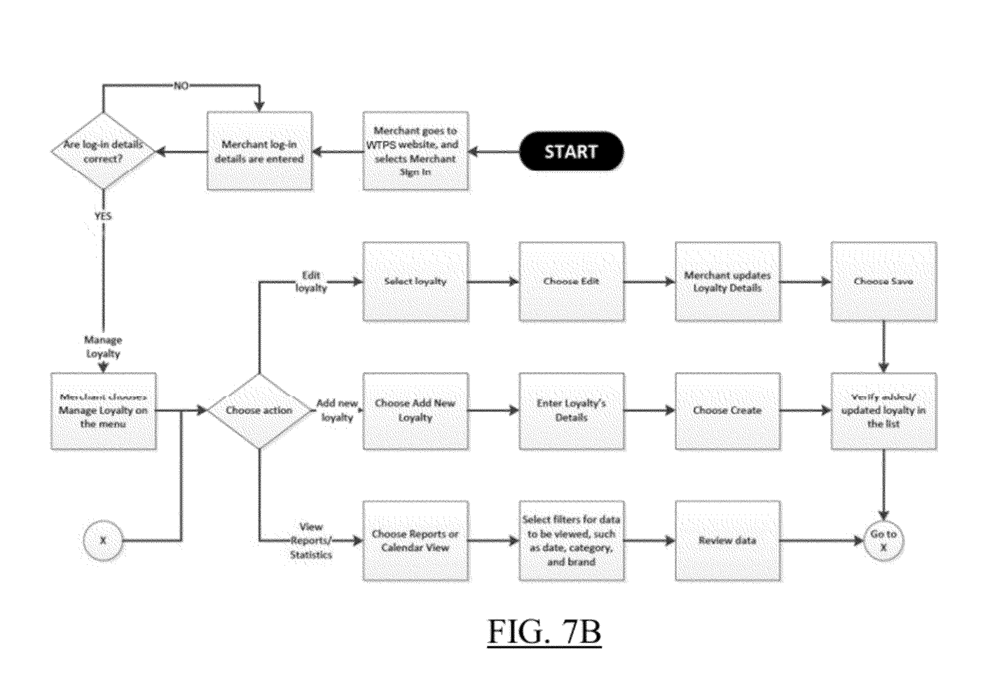

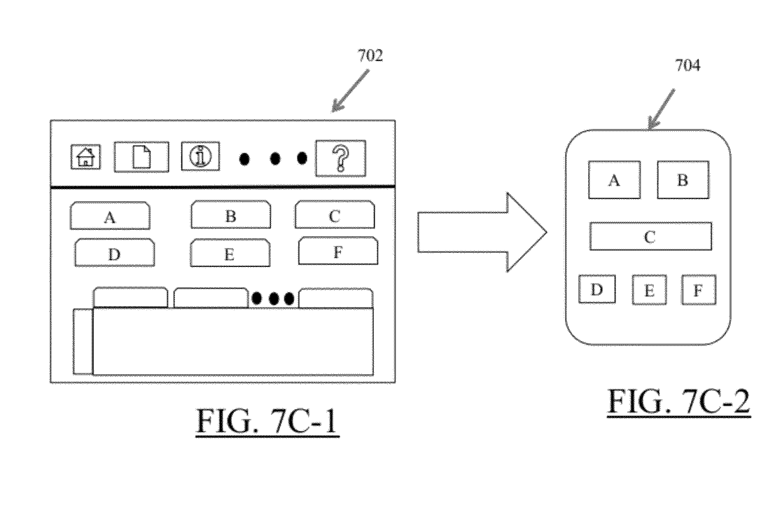

FIGS. 7A to 7C are non-limiting, exemplary illustrations of a loyalty system in accordance with the present invention. As illustrated and detailed below, the loyalty system of the present invention is comprised of at least two types—loyalty promotions (e.g., coupons, etc.) and loyalty rewards (e.g., rewards club cards, discounts on next purchases, etc.). FIG. 7A is a non-limiting exemplary illustration of a flowchart of a loyalty system from a consumer view in accordance with the present invention. The loyalty system of the present invention illustrated in FIG. 7A may be accessed by a consumer (for example at the operational functional act 238 of FIG. 2A) when the WTPS app of a mobile Internet device is launched in accordance with FIGS. 1A to 5E. The loyalty system of the present invention is a preference and GPS based system where loyalty promotions are “pushed” to mobile Internet devices of the registered buyers when they are within the proximity of a register seller. The primary server of the WTPS determines the types of loyalty promotions available for the locality of the consumer by searching databases related to the merchants and their loyalty promotions against the consumer preferences and pushing the information onto the mobile Internet device of the consumer near the corresponding locations. This classifies the loyalty system of the present invention as based on a location based push system. The registered buyer has the option of activating or deactivating the push function of the loyalty promotions and further, which specific type or category of loyalty promotions they would like to receive. The consumers also have the ability to search loyalty databases to view the types of loyalties available near their location or using other search criteria.

As further illustrated in FIG. 7A, the loyalty system of the present invention provides the consumers the ability to perform a full search of promotions and rewards to find specific types of promotions and rewards, including sharing and saving the results, and additionally, enabling the consumer to filter the results of their search as they desire. Therefore, the present invention provides both a promotion and rewards search engines enabling consumers to filter search results.

As illustrated, the loyalty system of the present invention further provides a My Loyalty section, which is a centralized location where the consumer may select to save loyalties (rewards and or promotions), add loyalties to a reserved loyalty cart for immediate use, save and retrieve loyalty rewards (e.g., retrieving a loyalty reward card of a store), and view a history of loyalties redeemed. The My Loyalty Cart enables users to search and retrieve various loyalty promotions and add them to their My Loyalty Cart ready for use during a checkout. For example, consumers may first search loyalty promotions and retrieve coupons for the products that they wish to purchase. As they review the retrieved coupons, they simply select to add them on the My Loyalty Cart (similar to an e-commerce “Shopping Cart Wish list”). Accordingly, My Loyalty Cart may have five or six “coupons” related to different products. At the point of sale (or at the checkout), the consumers simply retrieve the appropriate coupons from the My Loyalty Cart, and apply the specifically selected coupons from the cart against the products being purchased. Therefore, instead of searching and retrieving thousands of coupons, the consumer quickly access a selected number of coupons saved and stored to the My Loyalty Cart. To access My Loyalty Cart, the consumer simply selects the My Loyalty button, and then, selects My Loyalty Cart. It should be noted that during “checkout,” the consumer may further retrieve My Loyalty Rewards related to the specific merchant in addition to retrieving the selected promotions from the My Loyalty Cart to receive any discounts or promotions agreed by the merchant. For example, the My Loyalty Rewards may include a membership club card associated with a merchant that automatically provides discounts for its members. It should be noted that optionally, the My Loyalty Rewards information may automatically be loaded onto the mobile Internet device as soon as the consumer is within a store that includes loyalty rewards saved within the mobile Internet device of a consumer. Alternatively, the WTPS system may check to determine if a consumer is a loyalty reward member of that merchant and automatically offer the rewards membership to the consumer if they are near the merchant.

As further illustrated, the present invention also provides the option to consumers to receive loyalty information (rewards/promotions) via their optionally available WTPS internal email account. As with any email system, the WTPS email account of users enables users to receive emails and messages. Non-limiting examples of which may include WTPS information and updates, WTPS account information, merchant announcements or any other messages related to loyalties, enabling them to view individual offers. Additionally, consumers may elect to forward outside email/message correspondence from third party shopping environments to the WTPS email account in order to have all shopping correspondence in one location.

Loyalty system of the present invention further includes a program settings for consumers to set the types of promotions/rewards they wish to receive (via GPS push, email, or others). Non-limiting examples of settings may include category and subcategory of desired offers of products, desired business or locations, desired format and type of correspondence, activating or deactivating push notifications, enabling/disabling alerts, etc.

FIG. 7B is a non-limiting exemplary illustration of a flowchart of a loyalty system from a merchant view for setting loyalties (through the merchant tools) in accordance with the present invention. FIG. 7C-1 is a non-limiting exemplary illustration of a loyalty data sheet, and FIG. 7C-2 is a non-limiting exemplary illustration of template for displaying within WTPS application, the data contained within the loyalty datasheet (shown in FIG. 7C-1).

As illustrated, the merchant selects Manage Loyalty from within the merchant tool section, where they may select to edit loyalty, add new loyalty, or view loyalty related information (e.g., reports, statics, etc.).

The addition of a new loyalty (promotion or rewards) includes Loyalty item datasheet 702 (FIG. 7C-1) that functions similar to the above mentioned remote transaction (RT) item datasheet. The loyalty item datasheet 702 includes various fields that may be used to add media content (videos, texts, photos, audios, etc.) that describe the item for which a reward or a promotion (e.g., a coupon) is to be generated, including expiration dates of the loyalty, price discounts, or any other terms and conditions that is usually included as part of a “coupon.” Once completed, the loyalty item datasheet is saved to the loyalty database for later retrieval by a WTPS application. Retrieval of the loyalty item data on the WTPS application automatically generates a loyalty 704 (e.g., a coupon), which is shown in FIG. 7C-2, with its own identification (loyalty Item ID). It should be noted that the loyalty item ID may reference a row number on a spreadsheet within a database where, for example, the entire row of data includes all information from the completed loyalty datasheet. As described below, the row of data for the saved loyalty also includes one or more additional columns for associating a RT item ID of an RT item with the saved loyalty. The information displayed within the loyalty template 704 (shown in FIG. 7C-2) may be modified by editing a loyalty datasheet 702 within the loyalty database from the loyalty tools section of the merchant web portal.

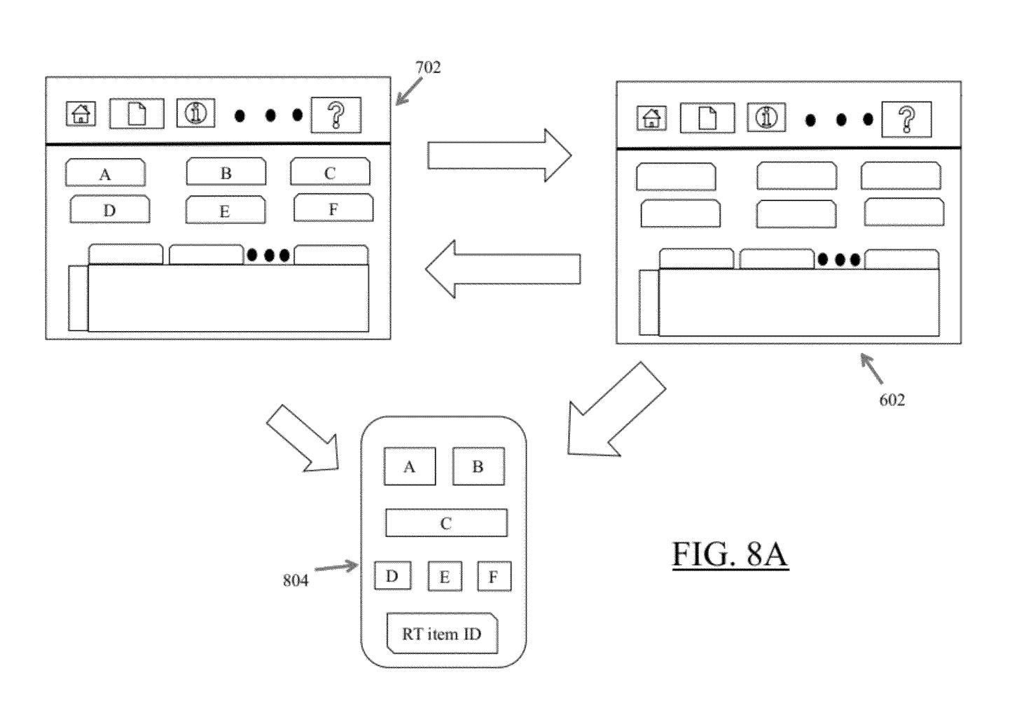

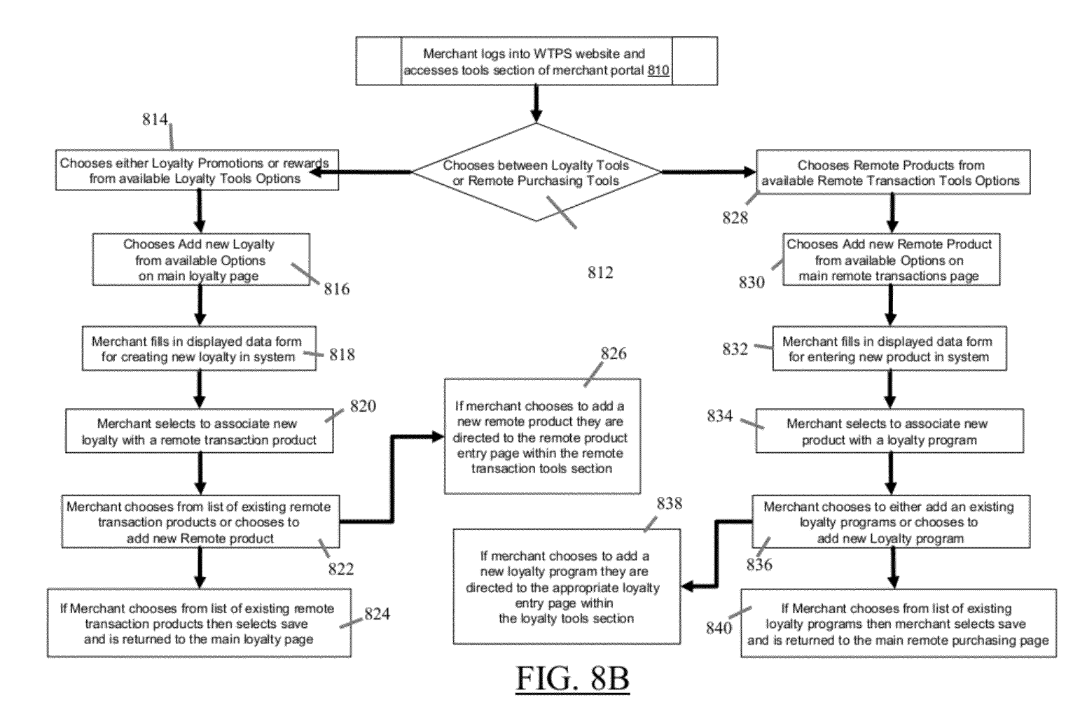

It should be reiterated that within WTPS platform, all modules (standalone or otherwise) are integrated and may work together to share options and data offering new features and benefits not available as separate modules. The combination of the remote transaction module (FIGS. 6A to 6F) and loyalty module (FIG. 7A to 7C) allows for buyers to redeem loyalty promotions and rewards immediately rather than waiting to go to a physical store or online site. In particular, FIGS. 8A and 8B are non-limiting exemplary illustrations that detail interactions of the RT and loyalty modules in accordance with the present invention.

As illustrated in FIG. 8A, in general, there are two methods to combining the RT and loyalty modules. A user may start with the loyalty module, create or edit a loyalty via the loyalty datasheet 702, and associate an RT item or RT catalog with that loyalty. Alternatively, the user may begin with the RT module, create or edit an RT item or RT catalog via the RT datasheet 602 and associate it with a loyalty. It should be noted that the RT item, RT catalog, or loyalty to be associated does not have to be pre-existing but may be created during the association process.

Consumers who have an installed and registered WTPS mobile application receive loyalty promotions and rewards pushed to their mobile device based on their GPS coordinates and saved preferences. Merchants will have previously entered in loyalty promotions and rewards through the merchant tools section of the merchant portal and indicated during their creation where and when these promotions or rewards will be distributed. As part of the loyalty creation process, merchants were given the option of associating remote transaction products with the newly created loyalties. If the merchant elected to associate remote transaction products with a loyalty then whenever that loyalty is displayed, a link allowing display and instant purchase of those remote transaction products will be displayed on the loyalty as it is pushed.

FIG. 8B is a non-limiting exemplary illustration of a flowchart for association between a loyalty and a remote transaction module in accordance with the present invention. As illustrated in FIG. 8B, at the operational functional act 810, the merchants began by logging in to the merchant portal on the WTPS website and selecting within the tools menu to work with either the loyalty promotions and rewards module or the remote transaction module (operational functional act 812). In process one, after opting (812) to begin within the loyalty promotions and rewards module (814), and choosing which form of loyalty they wish to work with, the merchant has the option of either editing existing loyalties or creating new ones (operational functional act 816). In the data form 702 (illustrated in FIG. 8A) associated with a loyalty's details, there are options including but not limited to title, description, image, redemption value, participating locations, valid time and dates, and whether to associate a remote transaction product with that loyalty, that the merchant may complete (operational functional act 818). If a merchant elects to associate a remote transaction product with the loyalty (operational functional act 820), they may choose to either select from a list of previously created products or create a new product entry (operational functional act 822). If the merchant chooses from an existing list of products (operational functional act 824), once their selections have been made, the merchant simply presses the save button to commit the entry to the loyalty database. If the merchant chooses to create a new product to associate with the loyalty (operational functional act 826), then selecting add new product commits the loyalty to the loyalty database and the WTPS merchant web portal optionally automatically opens the create new remote transaction product screen with the new loyalty automatically associated at the bottom of the data form (602 shown in FIG. 8A) for the new product. It should be noted that the loyalty created is associated with the final RT item ID, creating the loyalty with the associated RT product. The RT item ID (which may be represented in the form of a QR code) may be represented as a non-limiting, exemplary GUI as a form of a “buy now” button. That is, the QR code may or may not be displayed and instead, a non-limiting, exemplary GUI such as a “buy now” button may be displayed. Selecting the “buy now” GUI commences the RT transaction as described above.

As further illustrated in FIG. 8B, in process two, the procedure is similar however the merchant has opted (operational functional act 812) to begin work using the remote transaction module. In that situation, as illustrated in operational functional acts 828 or 830, the merchant will either choose from an existing list of remote products or elect to create a new one. In either event, the merchant opens a data form (602 shown in FIG. 8A) associated with a remote product details (and as indicated in the operational functional act 832) to fill in data associated with the product. These details are including but not limited to title, categories, description, image, price, shipping options, and recommended products. Additionally, as indicated in the operational functional act 834, the merchants are presented with an option to associate a loyalty with the RT item or catalog being viewed or created. At operational functional act 836, the merchant is presented with the option to use an existing loyalty program or create a new one. As indicated in the operational functional act 840, if the loyalty that the merchant desires already exists, they may select to associate the existing loyalty with the item, generating a loyalty item with the associated product (as referenced 804 shown in FIG. 8A). As further indicated in the operational functional act 838, the merchant may elect instead, to create a new loyalty. It should be noted that the loyalty 804 created is associated with the final RT item ID, creating the loyalty with the associated RT item ID of the RT item. The RT item ID (which may be represented in the form of a QR code) may be represented as a non-limiting, exemplary GUI as a form of a “buy now” button. That is, the QR code may or may not be displayed and instead, a non-limiting, exemplary GUI such as a “buy now” button may be displayed. Selecting the “buy now” GUI commences the RT transaction as described above.

As indicated in operational functional acts 838, in the event that there is not an existing loyalty that the merchant wishes to use, the merchant may elect to create a new loyalty. At that point, the currently opened product is saved to the product database (generating an RT item ID) and the merchant is optionally directed to the create new loyalty screen with the previously viewed product (its RT item ID) automatically associated with that loyalty. As further indicated in the operational functional act 840, if the merchant had chosen to associate an existing loyalty with the previously viewed product then after making their selections, the merchant would have simply pressed save to commit the product entry to the product database.

It should be noted that due to the combination of RT and Loyalty as a combined or integrated feature of WTPS, consumers may elect through the loyalty function of the WTPS to search for only loyalties that are offered by merchants that have an associated RT item or catalog. Additionally, consumers can also optionally elect to search for a list of merchants that have existing loyalties associated with an RT item or catalog.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, WTPS is capable of being installed directly onto a phone's internal SIM or micro-SD card memory and made available through the phone's internal menu. It is through this method that WTPS may be used with non-smartphone (e.g., feature phones), and other similar devices. Further, the WTPS can be restructured using a menu driven interface and using manual entry of related ID codes (e.g., within QR codes) for the system usage. The WTPS can be installed on non-smart mobile devices (e.g., feature phones) using the method. Further any data (e.g., RT item ID, seller ID, consumer ID, etc.) may be generally directly printed adjacent the representation of that data. For example, if the data is a seller ID, then the actual seller ID value may be printed adjacent its representation (non-limiting example of which may be a QR code). The actual or direct data (e.g., seller ID) is provided in case the user cannot or has no means of receiving a representation (e.g., a QR code) of the data. For example, a user may not have a QR code reader installed on their mobile Internet device at which point, the user may simply enter in the RT item ID manually. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. A wireless transaction processing system (WTPS), comprising:
a remote transaction module (RTM);
a RTM database that includes RTM item data for a product or service;
a RTM item ID associated with the RTM item data for the product or service;
the RTM item ID used in a variety of media, enabling access to and retrieval of the RTM item data associated with the product or service from one or more servers of WTPS, to display content of the RTM item data on the mobile device.

2. The contactless wireless transaction processing system as set forth in claim 1, wherein:
the displayed content of the RTM item data includes various controls for selection and transaction processes for the product or service, including further recommendations related to the selected product or service.

3. A remote transaction (RT) system, comprising:
a RT database that includes RT item data for a product or service;
a RT item ID associated with the RT item data for the product or service;
the RT item ID used in a variety of media, enabling access to and retrieval of the RTM item data associated with the product or service from one or more servers of RT, to display content of the RT item data on the mobile device.

4. The RT system as set forth in claim 3, wherein:
the displayed content of the RT item data includes various controls for selection and transaction processes for the product or service, including further recommendations related to the selected product or service.

5. A wireless transaction processing system (WTPS), comprising:
a loyalty module (LM);
a LM database that includes LM item data for a promotion or reward;
a LM item ID associated with the LM item data for the promotion or reward;
the LM item ID used in a variety of media, enabling access to and retrieval of the LM item data associated with the promotion or reward from one or more servers of WTPS, to display content of the LM item data on the mobile device.

6. A loyalty system, comprising:
a loyalty database that includes loyalty item data for a promotion or reward;
a loyalty item ID associated with the loyalty item data for the promotion or reward;
the loyalty item ID used in a variety of media, enabling access to and retrieval of the loyalty item data associated with the promotion or reward from one or more servers of loyalty system, to display content of the loyalty item data on the mobile device.

7. A system, comprising:
an integration between a loyalty system and a remote transaction system that allows for immediate purchase or redemption of at least one item presented through the loyalty system.

8. The system as set forth in claim 7, wherein:
the loyalty system is comprised of:
a loyalty database that includes loyalty item data for a promotion or reward;
a loyalty item ID associated with the loyalty item data for the promotion or reward;
the loyalty item ID used in a variety of media, enabling access to and retrieval of the loyalty item data associated with the promotion or reward from one or more servers of loyalty system, to display content of the loyalty item data on the mobile device.

9. The system as set forth in claim 7, wherein:
the remote transaction (RT) system is comprised of:
a RT database that includes RT item data for a product or service;
a RT item ID associated with the RT item data for the product or service;
the RT item ID used in a variety of media, enabling access to and retrieval of the RTM item data associated with the product or service from one or more servers of RT, to display content of the RT item data on the mobile device.

10. A wireless transaction processing system (WTPS), comprising:
a unified commerce architecture for multi-platform transactions and communications between disparate and distinct entities.

11. The WTPS as set forth in claim 10, wherein:
the unified commerce architecture includes one or more multi-configurable devices, enabling multi-platform transactions and communications between disparate and distinct entities.
